(19) United States
(12) Patent Application Publication
(10) Pub. No.: US 2010/0087230 A1
(43) Pub. Date: Apr. 8, 2010

(54) MOBILE COMMUNICATION DEVICE USER INTERFACE

(75) Inventors: Pendra C. Peh, Olathe, KS (US); Scott T. Moore, Olathe, KS (US)

Correspondence Address: GARMIN LTD.;C/O GARMIN INTERNATIONAL, INC., ATTN: Legal - IP, 1200 EAST 151ST STREET, OLATHE, KS, 66062, US

(73) Assignee: GARMIN LTD., Camana Bay (KY)

(21) Appl. No.: 12/566,122

(22) Filed: Sep. 24, 2009

Related U.S. Application Data
(60) Provisional application No. 61/100,181, filed on Sep. 25, 2008.

(51) Int. Cl. H04B 1/38; G06F 3/041

(52) U.S. Cl. 455/566; 345/173

(57) ABSTRACT

Techniques are described to provide a user interface for a display of a mobile communication device. In an implementation, a user interface comprises a main menu having a fixed portion and a movable portion. The fixed portion includes icons associated with primary functions of the mobile communication device (“primary icons”), while the movable portion includes icons associated with secondary functions of the mobile communication device (“secondary icons”). The secondary icons may be scrolled within the movable portion in response to receipt of a touch input via a touch screen overlaying the display while the primary icons within the fixed portion remain stationary with respect to the display.

### CROSS-REFERENCE TO RELATED APPLICATIONS

The present application claims the benefit under 35 U.S.C. §119(e) of U.S. Provisional Application Ser. No. 61/100,181, filed Sep. 25, 2008, which is herein incorporated by reference in its entirety.

### BACKGROUND

The popularity of mobile communication devices, such as mobile phones, smart phones, communication-enabled personal digital assistants, and so forth is ever increasing. Traditionally mobile communication devices were configured as single or limited function devices, such as a mobile phone limited to phone service, phone service and text messaging, and so on. As the popularity of mobile communication devices has increased, manufacturers have responded be developing cross-functional devices that provided multiple functions in a single device. For example, mobile communication devices, particularly smart phones, often provide functionality such as email, navigation, Internet browsing, media playback, media recording, and so on, in addition to phone service and text messaging.

Access to functionality provided by a mobile communication device is furnished through the device's user interface. Increasingly, user interfaces employ graphical icons displayed by a display of the mobile communication device to access the various functions provided by the device when selected. In most devices, the icons are arranged in a grid patterns in one or more menu screens of the user interface. Thus, little or no distinction is made between icons associated with commonly used functions, such as phone service functions or text messaging functions, and functions that are seldom used.

### SUMMARY

Techniques are described to provide a user interface for a display of a mobile communication device. In an implementation, a user interface comprises a main menu having a fixed portion and a movable portion. The fixed portion includes icons associated with primary functions of the mobile communication device (“primary icons”), while the movable portion includes icons associated with secondary functions of the mobile communication device (“secondary icons”). The secondary icons may be scrolled within the movable portion in response to receipt of a touch input via a touch screen overlaying the display while the primary icons within the fixed portion remain stationary with respect to the display.

This Summary is provided solely to introduce subject matter that is fully described in the Detailed Description and Drawings. Accordingly, the Summary should not be considered to describe essential features nor be used to determine scope of the claims.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 is an illustration an environment in an example implementation employing a mobile communication device that is operable to generate a user interface.

FIG. 2 is a flow diagram depicting a procedure in an example implementation in which a user interface is generated by the mobile communication device of FIG. 1.

FIG. 3 is an illustration depicting a main menu of the user interface generated by the mobile communication device of FIG. 1, wherein the user interface is shown in portrait mode.

FIG. 4 is an illustration depicting a main menu screen of the user interface generated by the mobile communication device of FIG. 1, wherein the user interface is shown in landscape mode.

FIG. 5 is an illustration depicting submenu screens of the user interface generated by the mobile communication device of FIG. 1 that provide access to functionality to answer an incoming telephone call.

FIG. 6 is an illustration depicting submenu screens of the user interface generated by the mobile communication device of FIG. 1 that provide access to functionality to conduct a telephone call.

FIG. 7 is an illustration depicting submenu screens of the user interface generated by the mobile communication device of FIG. 1 that provide access to functionality to enter alphanumeric and/or character selections during a call.

FIG. 8 is an illustration depicting submenu screens of the user interface generated by the mobile communication device of FIG. 1 that provide access to telephone calling functions of the user interface.

FIG. 9 is an illustration depicting submenu screens of the user interface generated by the mobile communication device of FIG. 1 that provide access to functionality to answer and conduct two or more simultaneous telephone calls.

FIG. 10 is an illustration depicting submenu screens of the user interface generated by the mobile communication device of FIG. 1 that provide access to functionality to conduct a conference call.

FIG. 11 is an illustration depicting screen-savers of the user interface generated by the mobile communication device of FIG. 1.

FIG. 12 is an illustration depicting submenu screens of the user interface generated by the mobile communication device of FIG. 1 that provide access to functionality to place a telephone call using the mobile communication device.

FIG. 13 is an illustration depicting submenu screens of the user interface generated by the mobile communication device of FIG. 1 that provide access to functionality to display call history of the mobile communication device.

FIG. 14 is an illustration depicting submenu screens of the user interface generated by the mobile communication device of FIG. 1 that provide access to functionality to display an address book/contacts list.

FIG. 15 is an illustration depicting submenu screens of the user interface generated by the mobile communication device of FIG. 1 that provide access to functionality to display information for a contact selected from the address book/contacts list shown in FIG. 14.

FIG. 16 is an illustration depicting submenu screens of the user interface generated by the mobile communication device of FIG. 1 that provide access to functionality to provide notification of a missed call from a contact of the address book/contacts list shown in FIG. 14.

FIG. 17 is an illustration depicting submenu screens of the user interface generated by the mobile communication device of FIG. 1 that provide access to functionality that provides a notification of a missed call from a party that is not in the address book/contacts list shown in FIG. 14.

FIG. 18 is an illustration depicting submenu screens of the user interface generated by the mobile communication device of FIG. 1 that provide access to functionality to initiate communication with a party identified as a point of interest from a database of points of interest.

FIG. 19 is an illustration depicting submenu screens of the user interface generated by the mobile communication device of FIG. 1 that provide access to functionality to display a map furnishing navigation information to a Point of Interest (POI).

FIG. 20 is an illustration depicting submenu screens of the user interface generated by the mobile communication device of FIG. 1 that provide access to functionality to display information describing movement of the mobile communication device.

FIG. 21 is an illustration depicting submenu screens of the user interface generated by the mobile communication device of FIG. 1 that provide access to functionality to display movement of the mobile communication device during navigation.

FIG. 22 is an illustration depicting submenu screens of the user interface generated by the mobile communication device of FIG. 1 that provide access to clock functionality.

FIG. 23 is an illustration depicting submenu screens of the user interface generated by the mobile communication device of FIG. 1 that provide access to alarm clock functionality.

FIG. 24 is an illustration depicting submenu screens of the user interface generated by the mobile communication device of FIG. 1 that provide access functionality to display a geochronic world map.

FIG. 25 is an illustration depicting submenu screens of the user interface generated by the mobile communication device of FIG. 1 that provide access to stop watch/timer functionality.

FIGS. 26 and 27 are illustrations depicting submenu screens of the user interface generated by the mobile communication device of FIG. 1 that provide access to calendar functionality wherein a monthly schedule is displayed.

FIGS. 28, 29 and 30 are illustrations depicting submenu screens of the user interface generated by the mobile communication device of FIG. 1 that provide access to calendar functionality wherein a weekly schedule is displayed in FIGS. 28 and 30, a weekly agenda is displayed in FIG. 29.

FIG. 31 is an illustration depicting submenu screens of the user interface generated by the mobile communication device of FIG. 1 that provide access to functionality to display a calendar entry.

FIG. 32 is an illustration depicting submenu screens of the user interface generated by the mobile communication device of FIG. 1 that provide access to functionality to enable recurring calendar entries.

FIG. 33 is an illustration depicting submenu screens of the user interface generated by the mobile communication device of FIG. 1 that provide access to functionality to select a time for a calendar entry.

FIGS. 34 and 35 are illustrations depicting submenu screens of the user interface generated by the mobile communication device of FIG. 1 that provide access to functionality to display a popup reminder for a calendar entry.

FIG. 36 is an illustration depicting submenu screens of the user interface generated by the mobile communication device of FIG. 1 that provide access to functionality to provide playback of stored media.

FIG. 37 is an illustration depicting submenu screens of the user interface generated by the mobile communication device of FIG. 1 that provide access to search functionality.

FIG. 38 is an illustration depicting submenu screens of the user interface generated by the mobile communication device of FIG. 1 that provide access to Internet browsing functionality.

FIG. 39 is an illustration depicting submenu screens of the user interface generated by the mobile communication device of FIG. 1 that provide access to functionality to send and receive messages.

FIG. 40 is an illustration depicting submenu screens of the user interface generated by the mobile communication device of FIG. 1 that provide access to functionality to compose a message.

FIG. 41 is an illustration depicting submenu screens of the user interface generated by the mobile communication device of FIG. 1 that provide access to functionality to display a received message.

FIG. 42 is an illustration depicting submenu screens of the user interface generated by the mobile communication device of FIG. 1 that provide access to functionality to configure (e.g., “set up”) an email account.

FIG. 43 is an illustration depicting submenu screens of the user interface generated by the mobile communication device of FIG. 1 that provide access to functionality to display weather information.

FIG. 44 is an illustration depicting submenu screens of the user interface generated by the mobile communication device of FIG. 1 that provide access to functionality to display a weather forecast.

FIG. 45 is an illustration depicting submenu screens of the user interface generated by the mobile communication device of FIG. 1 that provide access to functionality to display airline flight information for an airport.

FIG. 46 is an illustration depicting submenu screens of the user interface generated by the mobile communication device of FIG. 1 that provide access to functionality to display departure and/or arrival information for a particular flight.

FIG. 47 is an illustration depicting submenu screens of the user interface generated by the mobile communication device of FIG. 1 that provide access to functionality to facilitate currency conversion.

FIGS. 48 and 49 are illustrations depicting submenu screens of the user interface generated by the mobile communication device of FIG. 1 that provide access to functionality to provide entry of currency conversion information.

FIG. 50 is an illustration depicting submenu screen of the user interface generated by the mobile communication device of FIG. 1 that provides access to functionality to allow a user of the mobile communication device to compose a message.

FIG. 51 is an illustration depicting a submenu screen of the user interface generated by the mobile communication device of FIG. 1 that provide access to functionality to display navigation information.

FIG. 52 is an illustration depicting submenu screens of the user interface generated by the mobile communication device of FIG. 1 that provide access to functionality to display travel information.

FIGS. 53, 54, and 55 are illustrations depicting submenu screens of the user interface generated by the mobile communication device of FIG. 1 that provide access to functionality to select a point-of-interest (POI) from a POI database, wherein information is displayed to facilitate calling and/or navigating to the POI selected.

FIGS. 56 and 57 are illustrations depicting submenu screens of the user interface generated by the mobile communication device of FIG. 1 that provide access to functionality to select a POI from a POI database, wherein information is displayed to facilitate calling and/or navigating to the POI selected.

FIG. 58 is an illustration depicting submenu screens of the user interface generated by the mobile communication device of FIG. 1 that provide access to functionality to capture, store and/or geocode image media.

FIGS. 59, 60, 61, and 62 are illustrations depicting submenu screens of the user interface generated by the mobile communication device of FIG. 1 that provide access to social networking and/or friend finding functionality.

### DETAILED DESCRIPTION

### Overview

As the popularity of mobile communication devices has increased, manufacturers have responded by developing cross-functional devices that provide multiple functions in a single device. Traditionally, access to functionality provided by such mobile communication devices is furnished by the device's user interface via graphical icons displayed by the device's display. Thus, an icon may be selected by a user of the mobile communication device via a touch screen overlaying the device's display to access the associated functionality. However, common user interfaces employed by mobile communication devices allow the icons to be arranged in an arbitrary fashion in one or more menu screens. Thus, little or no distinction is made between icons that access frequently used functions and icons that access functions which are rarely utilized by the user. Consequently, the user may find it difficult to locate icons associated with desired functions of the mobile communication device to access such functions.

Accordingly, techniques are described to provide a user interface for a display of a mobile communication device. In an implementation, the user interface comprises a main menu having a fixed portion and a movable portion. Primary icons (e.g., icons associated with primary functions of the mobile communication device) are positioned within the fixed portion, while secondary icons (e.g., icons associated with secondary functions of the mobile communication device) are positioned within the movable portion. The secondary icons may be scrolled within the movable portion in response to a touch input received via a touch screen overlaying the display while the primary icons within the fixed portion remain stationary with respect to the display.

In embodiments, the mobile communication device may include an orientation sensor operable to determine an orientation of the device. The user interface may then be configured to be displayed in one of a portrait mode and a landscape mode in response to the determined orientation. When the user interface is displayed in the portrait mode, the movable portion is positioned to a side of the fixed portion with respect to the display. Thus, the secondary icons are aligned vertically and scroll in a vertical direction with respect to the display. Conversely, when the user interface is displayed in the landscape mode, the movable portion is positioned below or above the fixed portion with respect to the display. Thus, the secondary icons are aligned horizontally and scroll in a horizontal direction with respect to the display.

In the following discussion, an example mobile communication device environment is first described. Exemplary procedures are then described that may be employed with the example environment, as well as with other environments and devices without departing from the spirit and scope thereof. Main menu and submenu screens of an example user interface are then described that may be employed in the illustrated environment, as well as in other environments without departing from the spirit and scope thereof.

### Example Environment

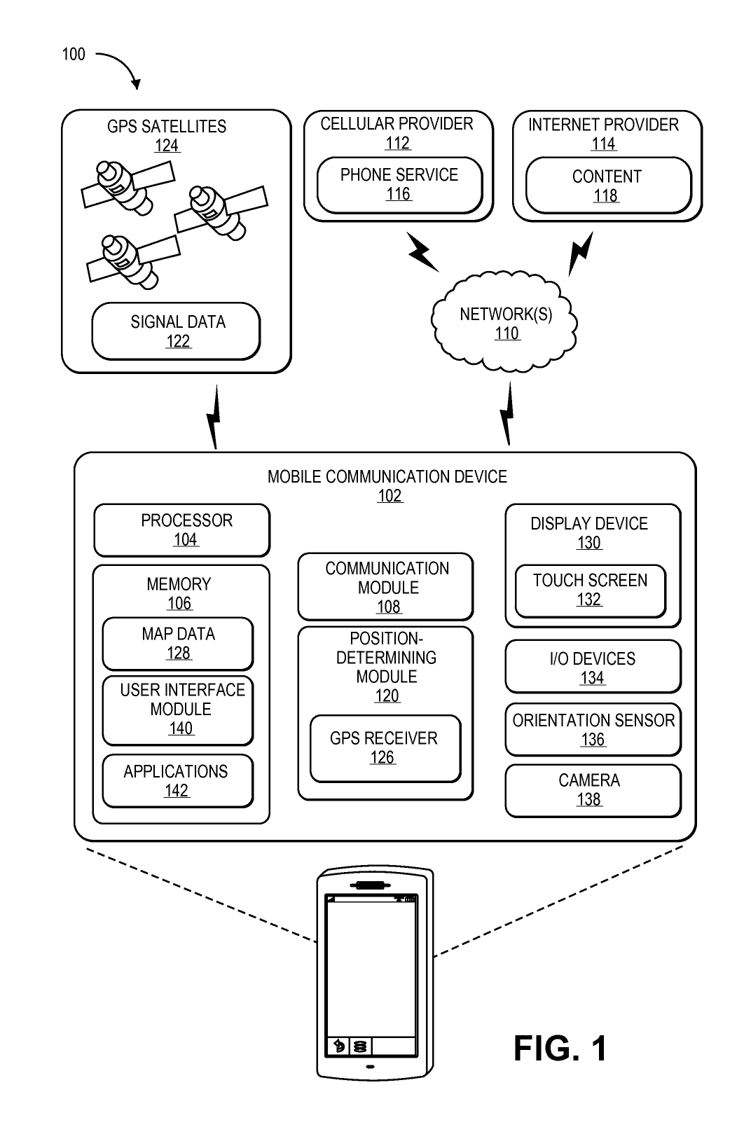

FIG. 1 illustrates an example mobile communication device environment 100 that is operable to perform the techniques discussed herein. The environment 100 includes a mobile communication device 102 operable to implement a user interface that controls the display of information and that allows a user to interact with the device 102. The mobile communication device 102 may be configured in a variety of ways. For instance, a mobile communication device 102 may be configured as a mobile phone, a smart phone, a position-determining device, a hand-held portable computer, a personal digital assistant, a multimedia device, a game device, combinations thereof, and so forth. In the following description, a referenced component, such as mobile communication device 102, may refer to one or more entities, and therefore by convention reference may be made to a single entity (e.g., the mobile communication device 102) or multiple entities (e.g., the mobile communication devices 102, the plurality of mobile communication devices 102, and so on) using the same reference number.

In FIG. 1, the mobile communication device 102 is illustrated as including a processor 104 and a memory 106. The processor 104 provides processing functionality for the mobile communication device 102 and may include any number of processors, micro-controllers, or other processing systems and resident or external memory for storing data and other information accessed or generated by the mobile communication device 102. The processor 104 may execute one or more software programs which implement the techniques and modules described herein. The processor 104 is not limited by the materials from which it is formed or the processing mechanisms employed therein, and as such, may be implemented via semiconductor(s) and/or transistors (e.g., electronic integrated circuits (ICs)), and so forth.

The memory 106 is an example of device-readable storage media that provides storage functionality to store various data associated with the operation of the mobile communication device 102, such as the software program and code segments mentioned above, or other data to instruct the processor 104 and other elements of the mobile communication device 102 to perform the techniques described herein. Although a single memory 106 is shown, a wide variety of types and combinations of memory may be employed. The memory 106 may be integral with the processor 104, stand-alone memory, or a combination of both. The memory may include, for example, removable and non-removable memory elements such as RAM, ROM, Flash (e.g., SD Card, mini-SD card, micro-SD Card), magnetic, optical, USB memory devices, and so forth. In embodiments of the mobile communication device 102, the memory 106 may include removable ICC (Integrated Circuit Card) memory such as provided by SIM (Subscriber Identity Module) cards, USIM (Universal Subscriber Identity Module) cards, UICC (Universal Integrated Circuit Cards), and so on.

Mobile communication device 102 also includes a communication module 108 representative of communication functionality to permit mobile communication device 102 to send/receive data between different devices (e.g., components/peripherals) and/or over the one or more networks 110. Communication module 108 may be representative of a variety of communication components and functionality including, but not limited to: one or more antennas; a browser; a transmitter and/or receiver; a wireless radio; data ports; software interfaces and drivers; networking interfaces; data processing components; and so forth.

The one or more networks 110 are representative of a variety of different communication pathways and network connections which may be employed, individually or in combinations, to communicate among the components of the environment 100. Thus, the one or more networks 110 may be representative of communication pathways achieved using a single network or multiple networks. Further, the one or more networks 110 are representative of a variety of different types of networks and connections that are contemplated including, but not limited to: the Internet; an intranet; a satellite network; a cellular network; a mobile data network; wired and/or wireless connections; and so forth.

Examples of wireless networks include, but are not limited to: networks configured for communications according to: one or more standard of the Institute of Electrical and Electronics Engineers (IEEE), such as 802.11 or 802.16 (Wi-Max) standards; Wi-Fi standards promulgated by the Wi-Fi Alliance; Bluetooth standards promulgated by the Bluetooth Special Interest Group; and so on. Wired communications are also contemplated such as through universal serial bus (USB), Ethernet, serial connections, and so forth.

The mobile communication device 102 through functionality represented by the communication module 108 may be configured to communicate via one or more networks 110 with a cellular provider 112 and an Internet provider 114 to receive mobile phone service 116 and various content 118, respectively. Content 118 may represent a variety of different content, examples of which include, but are not limited to: web pages; services; music; photographs; video; email service; instant messaging; and so forth.

In an implementation, the mobile communication device 102 may include functionality to determine position. More particularly, mobile communication device 102 may include a position-determining module 120 that may manage and process signal data 122 received from Global Positioning System (GPS) satellites 124 via a GPS receiver 126. For example, mobile communication device 102 may receive signal data 122 transmitted by one or more position data platforms and/or position data transmitters, examples of which are depicted as the GPS satellites 124. The position-determining module 120 is representative of functionality operable to determine a geographic position through processing of the received signal data 122. The signal data 122 may include various data suitable for use in position determination, such as timing signals, ranging signals, ephemerides, almanacs, and so forth.

Position-determining module 120 may also be configured to provide a variety of other position-determining functionality. Position-determining functionality, for purposes of discussion herein, may relate to a variety of different navigation techniques and other techniques that may be supported by “knowing” one or more positions. For instance, position-determining functionality may be employed to provide location information, timing information, speed information, and a variety of other navigation-related data. Accordingly, the position-determining module 120 may be configured in a variety of ways to perform a wide variety of functions. For example, the position-determining module 120 may be configured for outdoor navigation, vehicle navigation, aerial navigation (e.g., for airplanes, helicopters), marine navigation, personal use (e.g., as a part of fitness-related equipment), and so forth. Accordingly, the position-determining module 120 may include a variety of devices to determine position using one or more of the techniques previously described.

The position-determining module 120, for instance, may use signal data 122 received via the GPS receiver 126 in combination with map data 128 that is stored in the memory 106 to generate navigation instructions (e.g., turn-by-turn instructions to an input destination or POI), show a current position on a map, and so on. Position-determining module 120 may include one or more antennas to receive signal data 122 as well as to perform other communications, such as communication via the one or more networks 110. The position-determining module 120 may also provide other position-determining functionality, such as to determine an average speed, calculate an arrival time, and so on.

Although a GPS system is described and illustrated in relation to FIG. 1, it should be apparent that a wide variety of other positioning systems may also be employed, such as other global navigation satellite systems (GNSS), terrestrial based systems (e.g., wireless-phone based systems that broadcast position data from cellular towers), wireless networks that transmit positioning signals, and so on. For example, positioning-determining functionality may be implemented through use of a server in a server-based architecture, from a ground-based infrastructure, through one or more sensors (e.g., gyros, odometers, and magnetometers), use of “dead reckoning” techniques, and so on.

The mobile communication device 102 includes a display device 130 to display information to a user of the mobile communication device 102. In embodiments, the display device 130 may comprise an LCD (Liquid Crystal Diode) display, a TFT (Thin Film Transistor) LCD display, an LEP (Light Emitting Polymer) or PLED (Polymer Light Emitting Diode) display, and so forth, configured to display text and/or graphical information such as a graphical user interface. The display device 130 may be backlit via a backlight such that it may be viewed in the dark or other low-light environments.

The display device 130 may be provided with a touch screen 132 for entry of data and commands. For example, a user may operate the mobile communication device 102 by touching the touch screen 132 and/or by performing gestures on the screen 132. In some embodiments, the touch screen 132 may be a capacitive touch screen, a resistive touch screen, an infrared touch screen, combinations thereof, and the like. The mobile communication device 102 may further include one or more input/output (I/O) devices 134 (e.g., a keypad, buttons, a wireless input device, a thumbwheel input device, a trackstick input device, and so on). The I/O devices 134 may include one or more audio I/O devices, such as a microphone, speakers, and so on.

The mobile communication device 102 may further include an orientation sensor 136 that represents functionality to determine various manual manipulation of the device 102. Orientation sensor 136 may be configured in a variety of ways to provide signals to enable detection of different manual manipulation of the mobile communication device 102 including detecting orientation, motion, speed, impact, and so forth. For example, orientation sensor 136 may be representative of various components used alone or in combination, such as an accelerometer, gyroscope, velocimeter, capacitive or resistive touch sensor, and so on.

The mobile communication device 102 of FIG. 1 may be provided with an integrated camera 138 that is configured to capture media such as still photographs and/or video by digitally recording images using an electronic image sensor. Media captured by the camera 138 may be stored as digital image files in memory 106. In embodiments, the digital image files may be stored using a variety of file formats. For example, digital photographs may be stored using a Joint Photography Experts Group standard (JPEG) file format. Other digital image file formats include Tagged Image File Format (TIFF), Raw data formats, and so on. Digital video may be stored using a Motion Picture Experts Group (MPEG) file format, an Audio Video Interleave (AVI) file format, a Digital Video (DV) file format, a Windows Media Video (WMV) format, and so forth. Exchangeable image file format (Exif) data may be included with digital image files to provide metadata about the image media. For example, Exif data may include the date and time the image media was captured, the location where the media was captured, and the like. Digital image media may be displayed by display device 130 and/or transmitted to other devices via a network 110 (e.g., via an email or MMS text message).

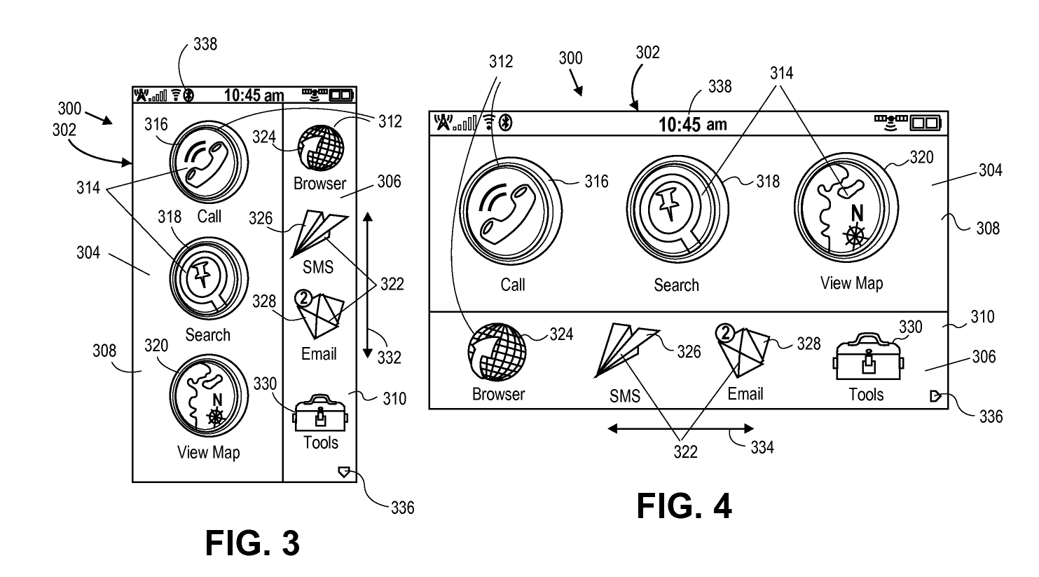

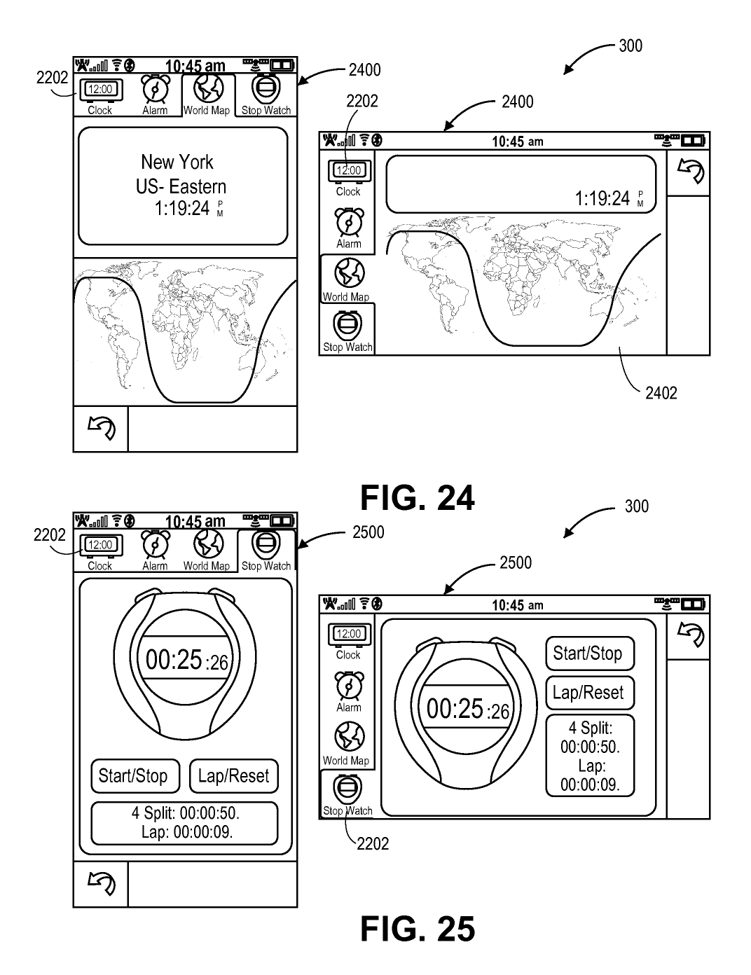

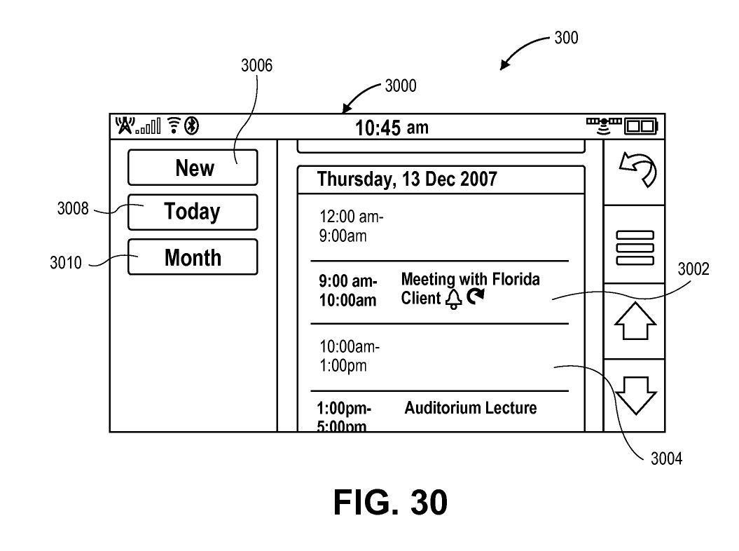

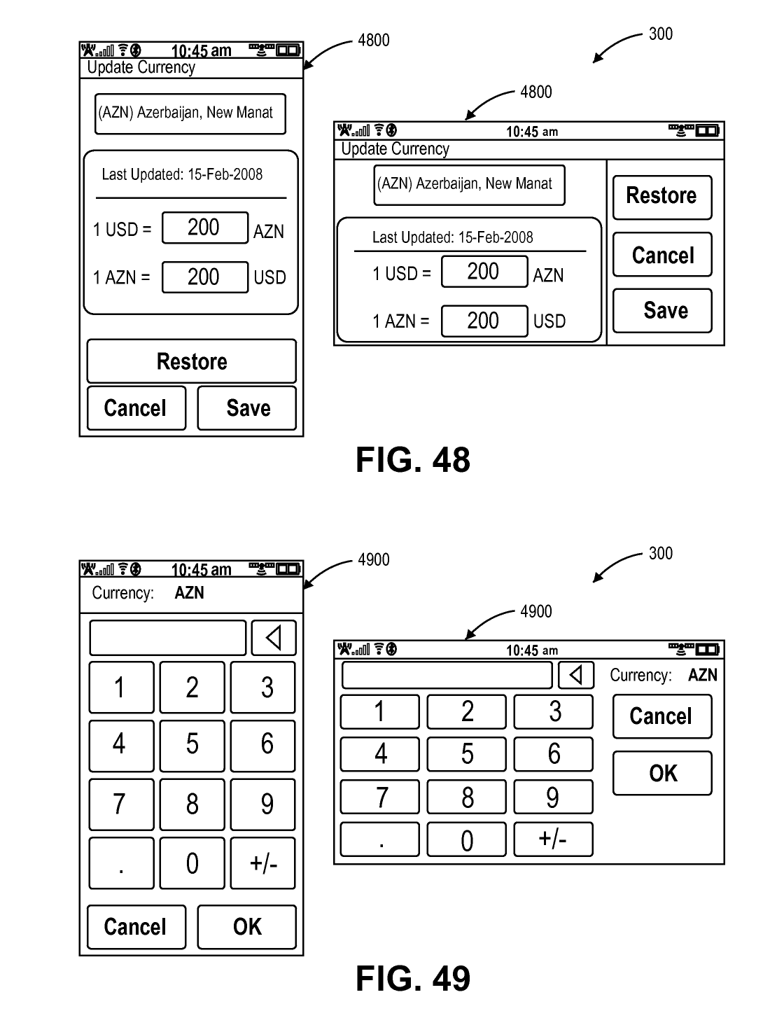

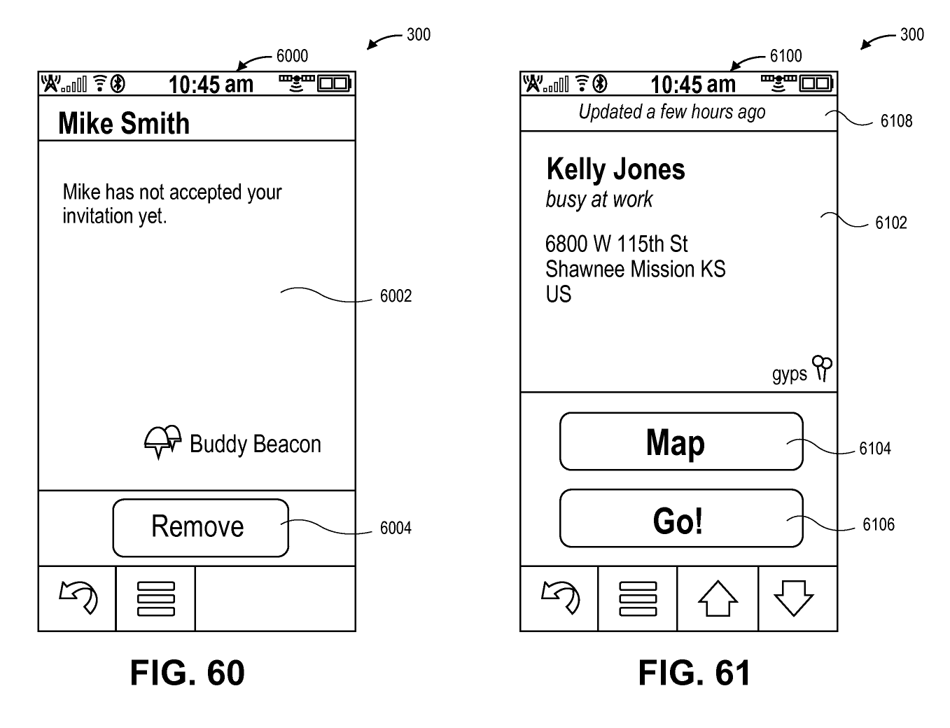

In accordance with the techniques described herein, the mobile communication device 102 is illustrated as including a user interface module 140, which is storable in memory 106 and executable by the processor 104. The user interface module 140 is representative of functionality to control the display of information and data to the user of the mobile communication device 102 via the display device 130. An example user interface 300 that may be implemented by the user interface module 140 is described in relation to FIGS. 3 through 62.

The user interface module 140 may provide functionality to allow the user to interact with one or more applications 142 of the mobile communication device 102 by providing inputs via the touch screen 132 and/or the I/O devices 134. For example, the user interface module 140 may cause an application programming interface (API) to be generated to expose functionality to an application 142 to configure the application 142 for display by the display device 130. In embodiments, the API may further expose functionality to configure the application 142 to allow the user to interact with an application 142 by providing inputs via the touch screen 132 and/or the I/O devices 134.

Applications 142 may comprise software, which is storable in memory 106 and executable by the processor 104, to perform a specific operation or group of operations to furnish functionality to the mobile communication device 102. Example applications 142 may include cellular telephone applications, instant messaging applications, browsers, photograph sharing applications, calendar applications, address book applications, and so forth.

Generally, any of the functions described herein can be implemented using software, firmware, hardware (e.g., fixed logic circuitry), manual processing, or a combination of these implementations. The terms “module” and “functionality” as used herein generally represent software, firmware, hardware, or a combination thereof. In the case of a software implementation, for instance, the module represents executable instructions that perform specified tasks when executed on a processor, such as the processor 104 with the mobile communication device 102 of FIG. 1. The program code can be stored in one or more device-readable storage media, an example of which is the memory 106 associated with the mobile communication device 102 of FIG. 1.

### Example Procedures

The following discussion describes procedures to provide a user interface for a display of a mobile communication device. Aspects of the procedures may be implemented in hardware, firmware, or software, or a combination thereof. The procedures are shown as a set of blocks that specify operations performed by one or more devices and are not necessarily limited to the orders shown for performing the operations by the respective blocks. In portions of the following discussion, reference may be made to the environment 100 of FIG. 1. The features of techniques described below are platform-independent, meaning that the techniques may be implemented on a variety of commercial device platforms having a variety of processors.

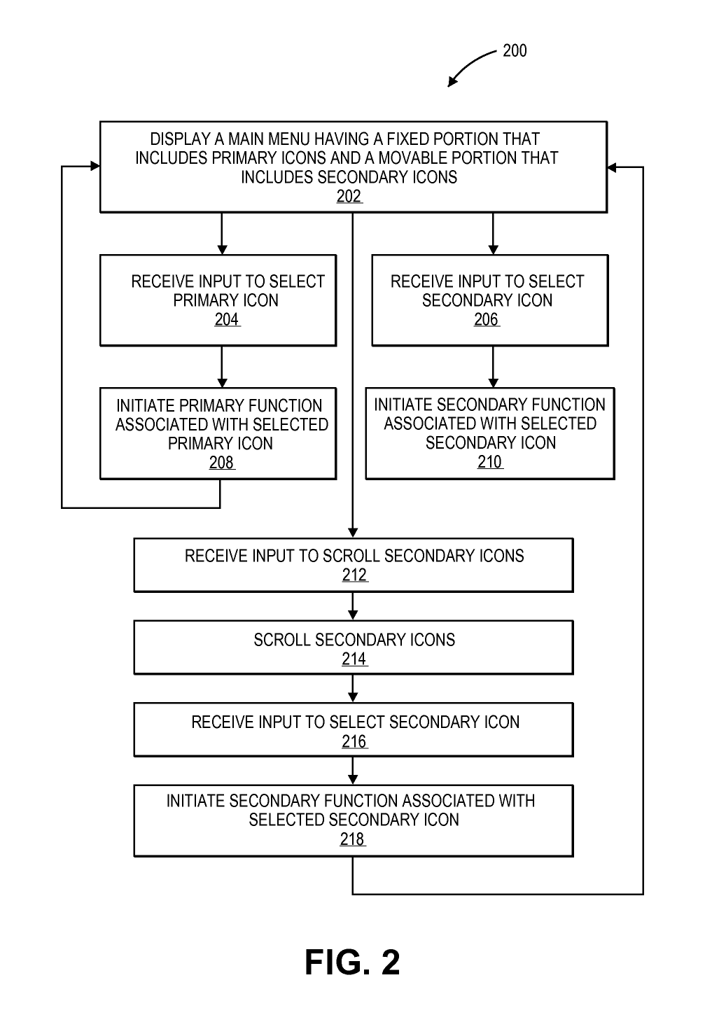

FIG. 2 depicts a procedure 200 in an example implementation in which a user interface may be generated for a mobile communication device. As shown, a display device of the mobile communication device is caused to display a main menu (Block 202) having a fixed portion and a movable portion. The fixed portion includes one or more primary icons associated with primary functions of the mobile communication device, while the movable portion includes secondary icons associated with secondary functions of the mobile communication device. Inputs may be received (e.g., via touch screen 132) to select a primary icon from the fixed portion to access a primary function of the mobile communication device (Block 204) or to select a secondary icon from the movable portion to access a secondary function of the mobile communication device (Block 206). The primary or secondary function associated with the selected icon may then be initiated (Block 208 or Block 210 respectively). For example, an application 142 associated with a selected secondary icon may be executed by the processor 104.

Inputs may further be received to scroll the secondary icons within the movable portion (Block 212). The secondary icons are then caused to be scrolled (Block 214) within the movable portion while the primary icons remain stationary within the fixed portion. For example, the received input (Block 212) may comprise a flick gesture input to the touch screen 132, wherein the secondary icons continue scrolling for a duration of time after receipt of the input (e.g., after the end of the flick gesture input). A second input may then be received (e.g., via the touch screen 132) to select a secondary icon from the movable portion to access a secondary function of the mobile communication device (Block 216). The secondary function associated with the selected secondary icon may then be initiated (Block 218), e.g., an application 142 associated with the secondary icon may be executed by the processor 104.

In embodiments, an orientation of the mobile communication device may be determined, e.g., via orientation sensor 136. Thus, when the user interface is displayed (Block 202), the user interface may be shown in one of a portrait mode and a landscape mode in response to the determined orientation. When the user interface is displayed in the portrait mode, the movable portion is positioned to a side of the fixed portion with respect to the display 130. The secondary icons are aligned vertically and scroll in a vertical direction. Conversely, when the user interface is displayed in the landscape mode, the movable portion is positioned above or below the fixed portion with respect to the display 130. The secondary icons are aligned horizontally and scroll in a horizontal direction. Moreover, the user interface may be dynamically configured to display icons as primary icons within the fixed portion or secondary icons within the movable portion based on, for example, a frequency of selection of the icons.

### Example User Interface

The following discussion describes elements of a user interface that may be generated using the processes and techniques discussed herein. Aspects of the user interface may be generated in hardware, firmware, software or a combination thereof. In portions of the following discussion, reference will be made to the environment 100 of FIG. 1, the procedures 200 of FIG. 2, and/or other example environments and procedures.

FIGS. 3 and 4 illustrate an example user interface 300 generated by the mobile communication device 102 of FIG. 1. As shown, user interface 300 presents a main menu 302 that includes a fixed portion 304 and a movable portion 306. Fixed portion 304 and movable portion 306 may have a variety of configurations. For instance, fixed portion 304 and movable portion 306 may comprise generally rectangular panes 308, 310 displayed by the display device 130. In embodiments, panes 308, 310 may be distinguished from one another in various ways. For example, panes 308, 310 may be distinguished using graphical elements such as lines, frames, shading, color, shapes, three-dimensional effects, combinations thereof, and so forth. In other embodiments, panes 308, 310 may be visually indistinguishable from one another (e.g., may contain no distinguishing graphical elements).

Fixed portion 304 may include icons 312 associated with primary functions of the mobile communication device 102 (i.e., primary icons 314). In the implementation illustrated, primary icons 314 include a call icon 316 to activate phone (e.g., cellular telephone) functionality, a search icon 318 to activate search functionality, and a map icon 320 to activate navigation/mapping functionality. However, primary icons 312 may include those icons 312 associated with any functionality identified as a primary function of the mobile communication device 102. In embodiments, primary functions of the mobile communication device 102 may be identified in a number of ways. For example, primary functions may comprise those functions identified by the manufacturer as key functions of the mobile communication device 102, such as phone functions, navigation/mapping functions, searching functions, and so on. Primary functions may also include functions identified by a user of the mobile communication device, and may include those functions considered most relevant by the user, most often used by the user, and so on. For example, a user may identify SMS messaging as a primary function if that user frequently uses SMS messaging functionality of the mobile communication device 102.

Movable portion 306 may include icons 312 associated with secondary functions of the mobile communication device 102 (i.e., secondary icons 322). Secondary functions may include those functions of the mobile communication device 102 that are not identified as primary functions (e.g., by the manufacturer, by a user, by the mobile communication device 102, and so on). Thus, secondary icons 322 may include application-specific icons such as a browser icon 324, an SMS texting icon 326, an email client icon 328, a device configuration icon 330, and the like.

It is contemplated that icons 312 may be identified as either primary icons 314 or secondary icons 322 under different circumstances. For instance, in some embodiments, icons 312 may be dynamically configured by a user and/or the mobile communication device 102. Thus, those icons 312 determined to be most relevant to a user of the device 102 (e.g., those icons 312 that are most often utilized) are presented as primary icons 314 within the fixed portion 304 of the main menu 302, while those icons 312 determined to be less relevant (e.g., those icons 312 that are utilized less often) are presented as secondary icons 322 within the movable portion 306. For example, the user interface module 140 (FIG. 1) may include functionality that allows the mobile communication device to track the frequency of selection of the various icons 312. Those icons that are selected most frequently may be identified as primary icons 314, while those icons 312 that are selected less frequently are presented as secondary icons 322. Identification of icons 312 as primary icons 314 or secondary icons 322 may be automatic or may require user intervention (e.g., a user of the mobile communication device 102 may be prompted to change a secondary icon 322 to a primary icon 314 or a primary icon 314 to a secondary icon 322). Thus, the various icons 312 comprising the primary icons 314 and secondary icons 322 may be swapped based on user preferences.

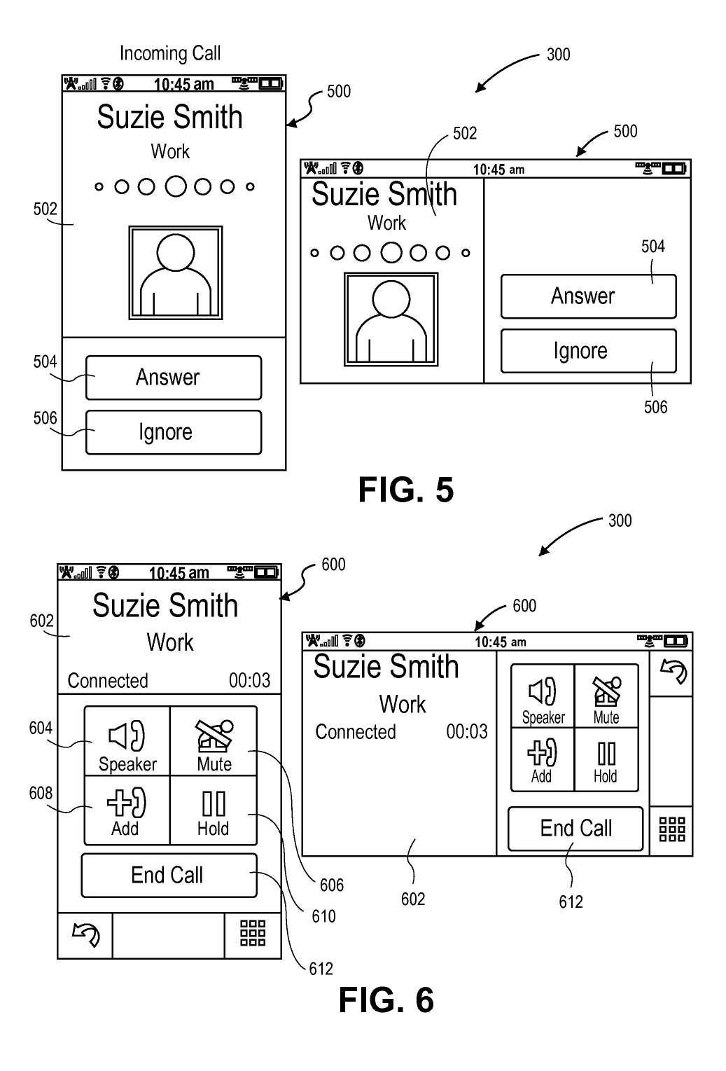

The main menu screen 302 (and/or the other submenu screens 500-6200 of FIGS. 5 through 62) may be presented in a portrait configuration, shown in FIG. 3, or a landscape configuration, shown in FIG. 4, depending on a sensed orientation of the mobile communication device 102. Thus, as the user rotates the mobile communication device 102, the main menu screen 302 (or submenu screens 500-6200) may be switched between landscape and portrait configurations to present a suitable view to the user. For instance, the orientation sensor 136 may determine the orientation of the mobile communication device 102. The user interface module 140 may include functionality that causes the user interface 300 to be displayed in one of a portrait mode and a landscape mode in response to the determined orientation. When the user interface 300 is displayed in the portrait mode, the movable portion 306 of the main menu screen 302 is positioned to a side of the fixed portion 304 with respect to the display device 130. The secondary icons 322 are aligned vertically and scroll in a vertical direction (as indicated by arrow 332). Conversely, when the user interface 300 is displayed in the landscape mode, the movable portion 306 of the main menu screen 302 is positioned above or below the fixed portion 304 with respect to the display 130. The secondary icons 322 are aligned horizontally and scroll in a horizontal direction (indicated by arrow 334).

In the implementation shown, the fixed portion 304 is positioned on the left side of the main menu screen 302 when in portrait mode and on the top of the screen 302 when in landscape mode. This configuration enables the user to easily locate the primary icons 314 presented within the fixed portion 304 regardless of the orientation of the mobile communication device 102. However, it is contemplated that the fixed portion 304 may also be positioned on the right side of the main menu screen 302 (e.g., for a user who is left-handed) when in portrait mode and/or on the bottom of the screen 302 when in landscape mode.

As noted, the movable portion 306 of the main menu screen 302 may be scrolled in response to a touch input received via the touch screen 132 to allow the user to view and access the secondary icons 322. For instance, it is contemplated that more secondary icons 322 may be provided by the user interface 300 than can be presented within the movable portion 306 of the main menu screen 302 at any given time. Consequently, the user interface module 140 may include functionality that causes the secondary icons 322 to be scrolled onto and off of the main menu screen 302 within movable portion 306 in response to the touch input, while the primary icons 314 remain stationary within the fixed portion 304.

For example, the movable portion 306 may be scrolled by a user via a “dragging” touch input (e.g., by a user moving his or her fingertip along the touch screen 132 of the mobile communication device 102 in a linear motion) to allow the user to view and/or select additional secondary icons 322. In this manner, secondary icons 322 that were not displayed initially are scrolled onto the main menu screen 302, while secondary icons 322 that were displayed are simultaneously scrolled off the screen 302 in a sequential manner in the direction of movement of the touch input (e.g., in the direction indicated by arrows 332, 334). Thus, as shown in FIG. 3, a downward input may cause undisplayed secondary icons 322 to be scrolled onto the movable portion 306 from the top of the main menu screen 302, while displayed secondary icons 322 are scrolled off of the movable portion 306 from the bottom of the screen 302. Conversely, an upward input may cause undisplayed secondary icons 322 to be scrolled onto the movable portion 306 from the bottom of the main menu screen 302, while displayed secondary icons 322 are scrolled off of the movable portion 306 from the top of the screen 302. Similarly, as shown in FIG. 4, a rightward input may cause undisplayed secondary icons 322 to be scrolled onto the movable portion 306 from the left of the main menu screen 302, while displayed secondary icons 322 are scrolled off of the movable portion 306 from the right of the screen 302. Conversely, a leftward touch input may cause undisplayed secondary icons 322 to be scrolled onto the movable portion 306 from the right of the main menu screen 302, while displayed secondary icons 322 are scrolled off of the movable portion 306 from the left of the screen 302. An indication (e.g., arrow icon 336) may be displayed to advise the user that additional secondary icons 322 may be viewed by scrolling the icons 322 and/or to indicate a direction in which the secondary icons 322 may be scrolled.

It is contemplated that the secondary icons 322 may be arranged in a predetermined scrolling order to aid the user in locating a desired icon 322. Thus, the secondary icons 322 may be scrolled onto and off from the movable portion 306 of the main menu screen 302 in a predetermined order. The predetermined scrolling order may be set by the manufacturer, the mobile communication device 102, a user, a combination thereof, and the like. For example, the user may order secondary icons 322 in a desired scrolling order via a setup operation, such as a drag and drop operation in which the icons 322 are dragged and dropped into the movable portion 306 in the desired order.

In some embodiments, the movable portion 306 may be movable through gesture inputs. For example, the touch input may comprise a flick gesture input, wherein the secondary icons 322 continue scrolling for a duration of time after receipt of the input (e.g., after the flick gesture input has ended and the user has removed his or her fingertip from the touch screen 132). Thus, the user may flick the movable portion 306 to rapidly scroll through the secondary icons 322 without being required to manually drag the movable portion 306 through direct contact with the touch screen 132. In this manner, the user may quickly and efficiently locate a desired secondary icon 322 through minimal physical interaction with the touch screen 132. The secondary icon 322 may then be selected via a second touch input (e.g., a tap, double tap, or the like) received via the touch interface to access the secondary function of the mobile communication device 102 associated with the icon 322 (e.g., an application 142 associated with the secondary icon 322 may be executed by the processor 104 of the mobile communication device 102).

Selection of icons 312 (e.g., primary icons 314 or secondary icons 322) may cause submenu screens to be displayed by the user interface 300 to access functionality of the mobile communication device 102. Accordingly, example submenu screens 500-6200 are now described in reference to FIGS. 5 through 62. In implementations, submenu screens 500-6200 may be nested in levels beneath the main menu screen 302. Thus, in some instances, a submenu screen may be accessed by navigating (e.g., “drilling down”) from the main menu screen 302 through other, intermediate submenu screens. Further, in FIGS. 5 through 62, the sub-menu screens 500-6200 are shown in both portrait mode and landscape mode, where applicable. FIGS. 5 through 62 illustrate example menu submenu screens 500-6200. However, it is contemplated that a variety of other submenu screens may be provided by the user interface 300 and accessed through main menu screen 302 to allow the user to interact with additional functionally provided by the mobile communication device 102.

FIG. 5 illustrates submenu screens 500 of the user interface 300 that provide access to functionality to answer an incoming telephone call. As shown, the submenu screens 500 may include identification information 502 (e.g., name, address book category, image, etc.) of the caller and button icons to answer 504 or ignore 506 the caller.

FIG. 6 illustrates submenu screens 600 of the user interface 300 that provide access to functionality to conduct a telephone call. As shown, the submenu screens 600 include identification information 602 for the caller and button icons to place the caller on speaker 604, mute the caller 606, add the caller to an address book or contacts list 608, or place the caller on hold 610. A button icon is also provided to end the call 612.

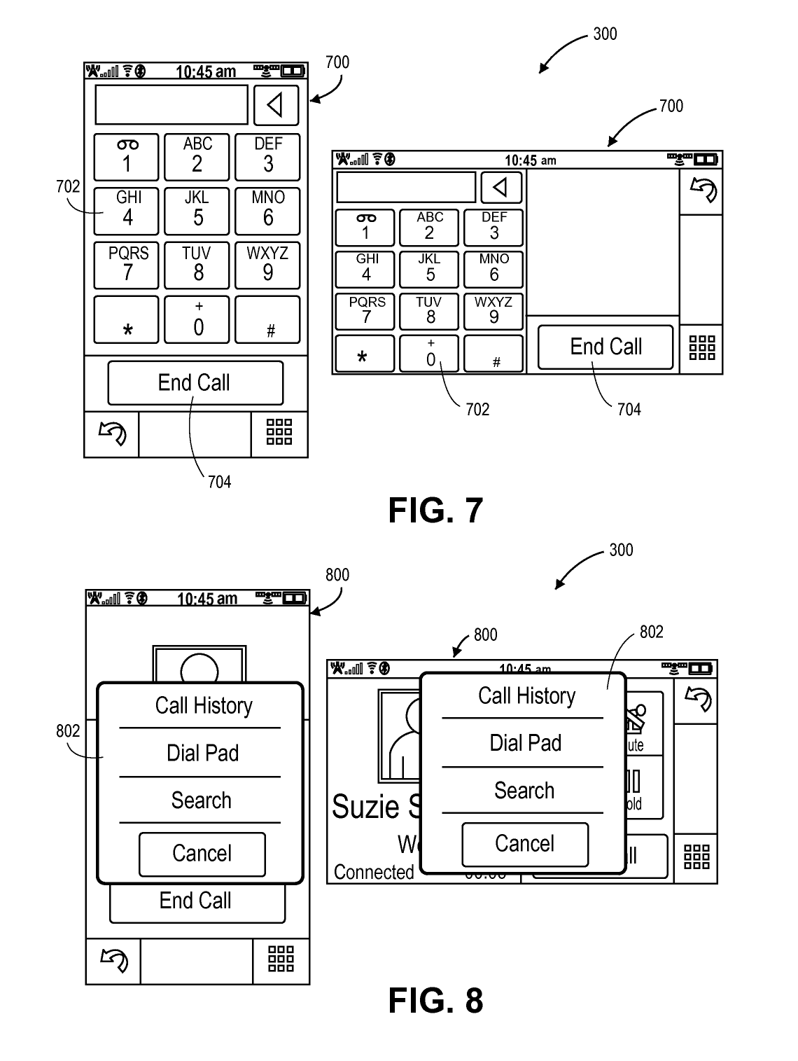

FIG. 7 illustrates submenu screens 700 of the user interface 300 that provide access to functionality to facilitate alphanumeric and/or character input during a call. As shown, the submenu screens 700 include a keypad 702, which may be configured for T9 text input. A button icon is also provided to end the call 704.

FIG. 8 illustrates submenu screens 800 of the user interface 300 that provide access to functionality to access telephone calling functions of the user interface. As shown, the submenu screens 800 include a popup menu 802 that provides access to call history for a caller, a dial pad (e.g., submenu screen 700 of FIG. 7), and search functionality.

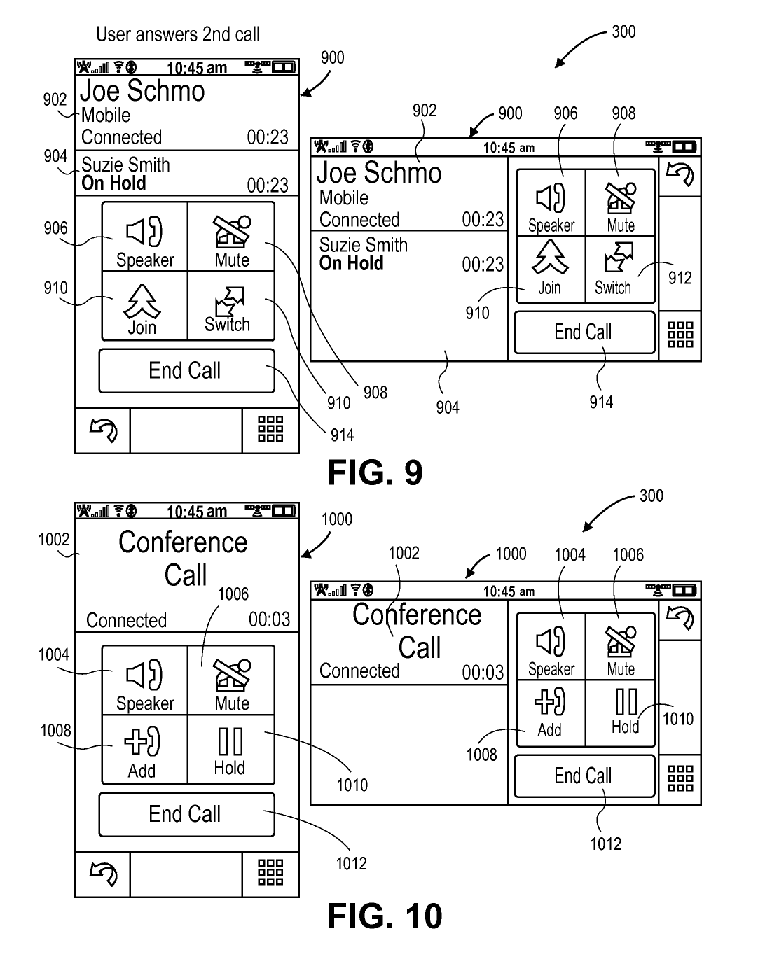

FIG. 9 illustrates submenu screens 900 of the user interface 300 that provide access to functionality to answer and conduct two or more simultaneous telephone calls. As shown, the submenu screens 900 include identification information for a currently connected caller 902 and one or more callers who are on hold 904. The submenus screens 900 also include button icons to place the currently connected caller on speaker phone 906, mute the currently connected caller 910, join the currently connected caller and the one or more of the callers on hold in a conference call 910, or switch the currently connected caller with the caller on hold 912 so that the currently connected caller is placed on hold and the caller on hold is connected for conversation. A button icon is also provided to end the call with the currently connected caller and/or the caller on hold 914.

FIG. 10 illustrates submenu screens 1000 of the user interface 300 that provide access to functionality to conduct a conference call. As shown, submenu screens 1000 include information alerting the user of the conference call 1002 and button icons to place the conference call on speaker 1004, mute the conference call 1006, add callers in the conference call to an address book or contacts list 1008, or place the conference call on hold 1010. A button icon is also provided to end the call 1012.

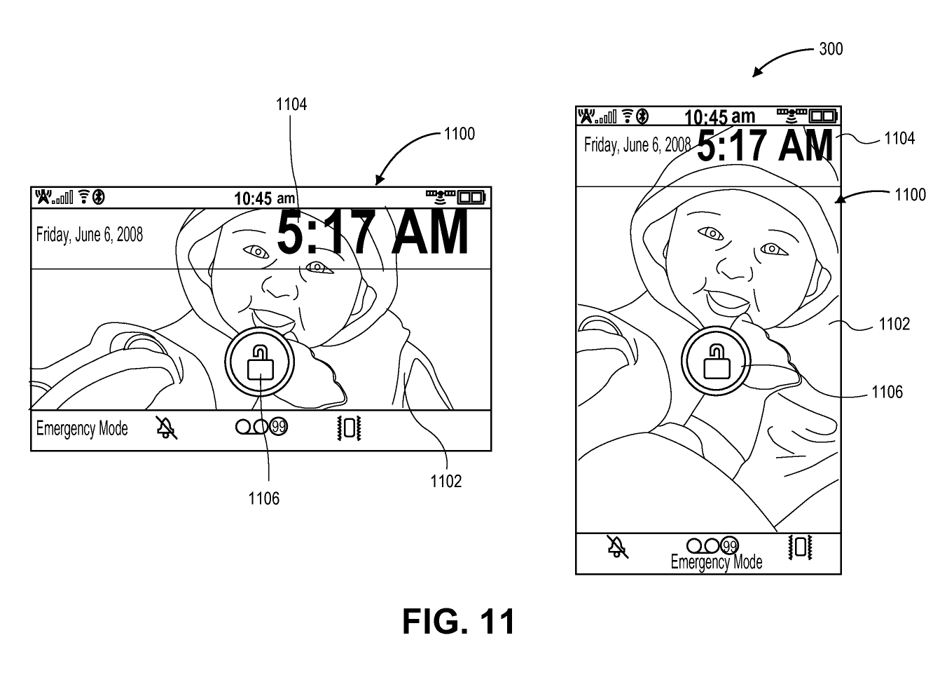

FIG. 11 illustrates screen-saver screens 1100 of the user interface 300. As shown, the screen-saver screens 1100 may include a background 1102 (e.g., a photograph, graphic, or the like), which may be selected by a user of the mobile communication device 102. A clock 1004, which may include the current time and date, is displayed over the background. A lock icon 1006 allows the user to unlock the screen-saver screens 1100 to access functionality of the mobile communication device 102. For instance, in embodiments, the screen-saver screens 1100 may be unlocked by a user via a double tap input to the touch screen 132 over the lock icon 1106 to furnish access to the user interface 300 (e.g., main menu screen 302 of FIGS. 3 and 4). Other lock/unlock configurations (e.g., an unlock slide) are possible.

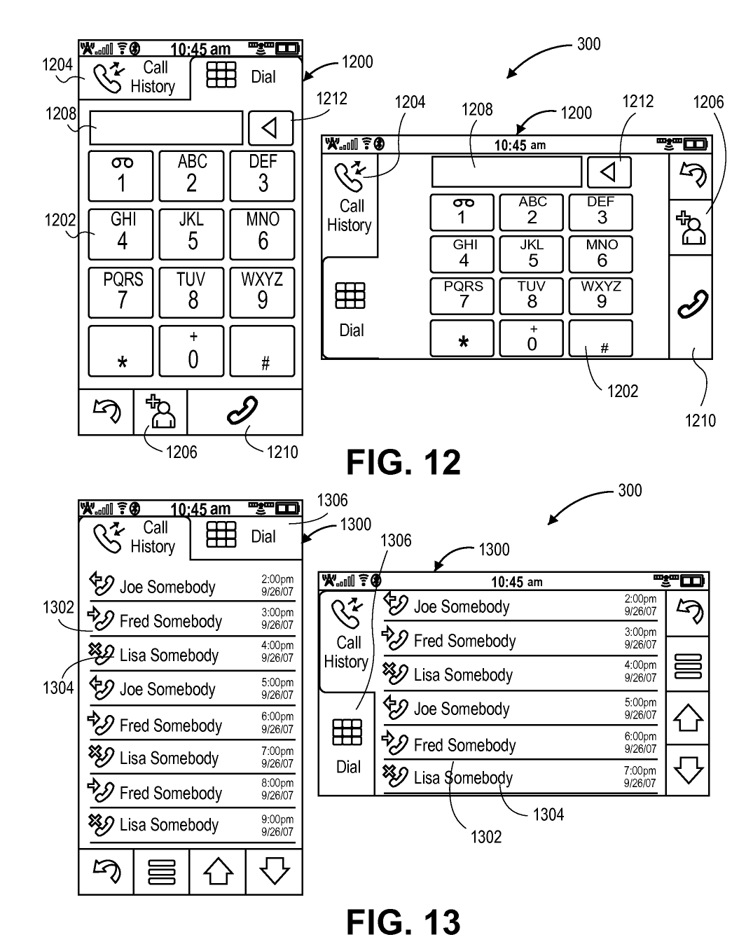

FIG. 12 illustrates submenu screens 1200 of the user interface 300 that provide access to functionality to place a telephone call using the mobile communication device 102. As shown, the submenu screens 1200 include a keypad 1202, which may be configured for T9 text input. A tab graphic is provided to access a call history 1204 for the mobile communication device 102 (e.g., to display submenu screen 1300 of FIG. 13), while a button icon is provided to access an address book or contacts list 1206 which may stored in the device's memory 106. A display area 1208 displays the inputted telephone number. A button icon is provided to place the call 1210 upon completion of entry of the telephone number. A delete/backspace button icon 1212 is provided to delete erroneous entries.

FIG. 13 illustrates submenu screens 1300 of the user interface 300 that provide access to functionality to display a call history of the mobile communication device 102. Calls including received calls, missed calls, placed calls and the like are displayed as entries 1302 of a call history listing 1304. Each entry may include the identity of the caller, if available, an indication that the entry is a received call, a missed call or a placed call, and the date and time of the call. A tab graphic is provided to access call dialing functionality 1306 of the mobile communication device 102 (e.g., to display submenu screens 1200 of FIG. 12).

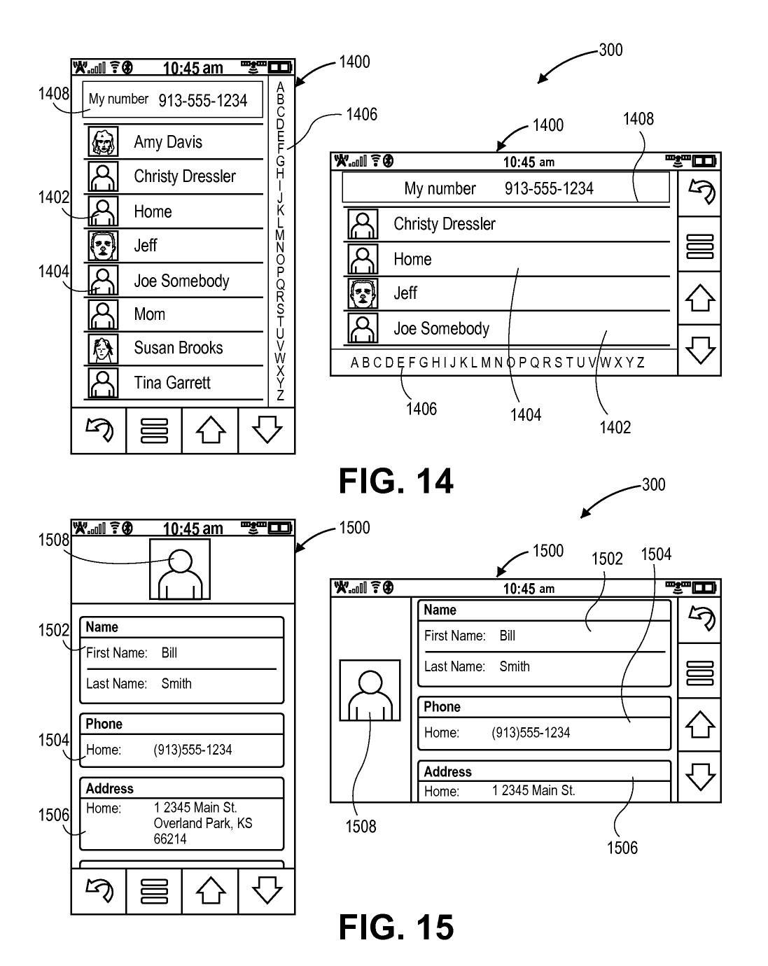

FIG. 14 illustrates submenu screens 1400 of the user interface 300 that provide access to functionality to display an address book/contacts list for the mobile communication device 102. As shown, the submenu screen 1400 includes entries 1402 for entities stored within the address book/contacts list 1404. In embodiments, each entry 1402 may include information such as the identification (e.g., name) of the contact and a photograph of the contact that allow the contact to be identified. An alphabetic search bar 1406 allows for efficient searching of entries, which may be arranged in alphabetical order. The telephone number 1408 of the mobile communication device 102 may also be provided for the user's reference.

FIG. 15 illustrates submenu screens 1500 of the user interface 300 that provide access to functionality to display information for a contact selected from the address book/contacts list 1404 shown in FIG. 14. As shown, a variety of information may be stored for each contact entry. For instance, in embodiments, submenu screen 1500 may include information such as the identification (e.g., name) of the entry 1502, phone numbers (e.g., home, work, facsimile, mobile phone, etc.) of the entry 1504, addresses (e.g., work and home address) of the entry 1506, a photograph of the contact 1508, and so on. Other information that may be provided includes, but is not limited to, social networking identities (e.g., usernames, screen names, and the like), email addresses, map coordinates, current location, the birthday of the contact, anniversary dates, or an audio or video file associated with the contact.

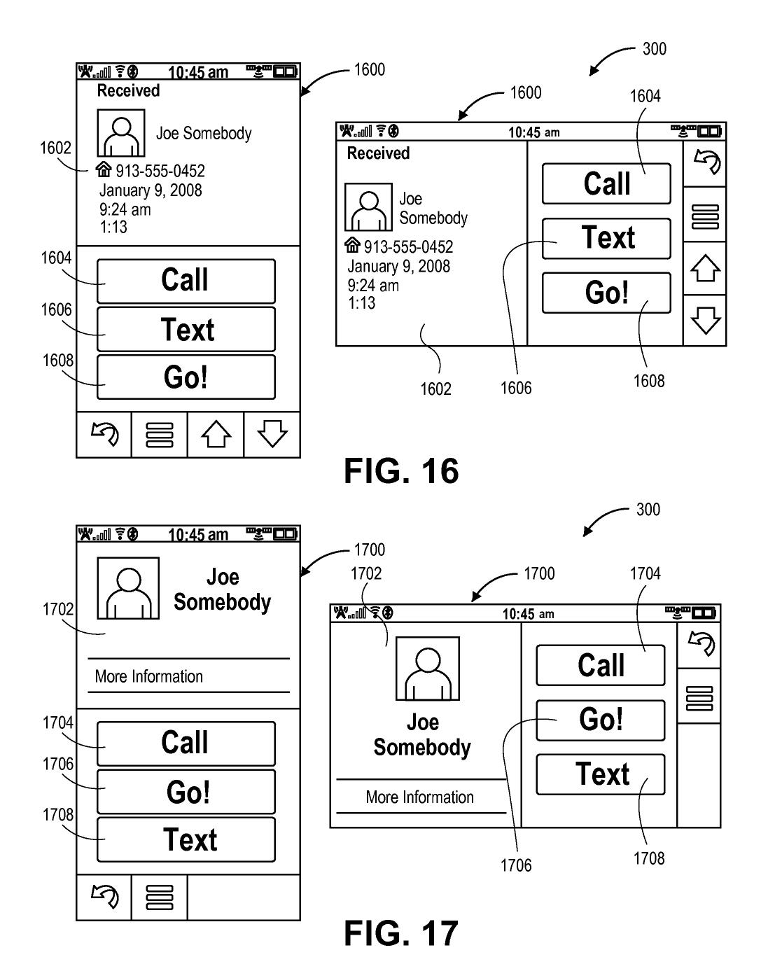

FIG. 16 illustrates submenu screens 1600 of the user interface 300 that provide access to functionality to provide notification of a missed call from a contact of the address book/contacts list 1404 shown in FIG. 14. As shown, the submenu screens 1600 may include identification information 1602 for the caller such as the name of the caller, a photograph of the caller, the date and time of the call, the duration of the missed call, and so on. Button icons may be provided to return the call 1604, to initiate functionality to create and send a text message to the caller 1606, or to initiate navigation functionality to navigate to a location associated with the caller (e.g., the caller's current location, a stored location for the caller, and so on) 1608.

FIG. 17 illustrates submenu screens 1700 of the user interface 300 that provide access to functionality to provide notification of a missed call from a party not in the address book/contacts list 1404 shown in FIG. 14. As shown, the submenu screens 1700 may include identification information 1702 for the caller (e.g., information received from caller identification services provided by the cellular provider 112 via a network 110). Button icons may be provided to return the call 1704, to initiate navigation functionality to navigate to a location associated with the caller (e.g., the caller's current location, a stored location for the caller, and so on) 1706, or to initiate functionality to create and send a text message to the caller 1708.

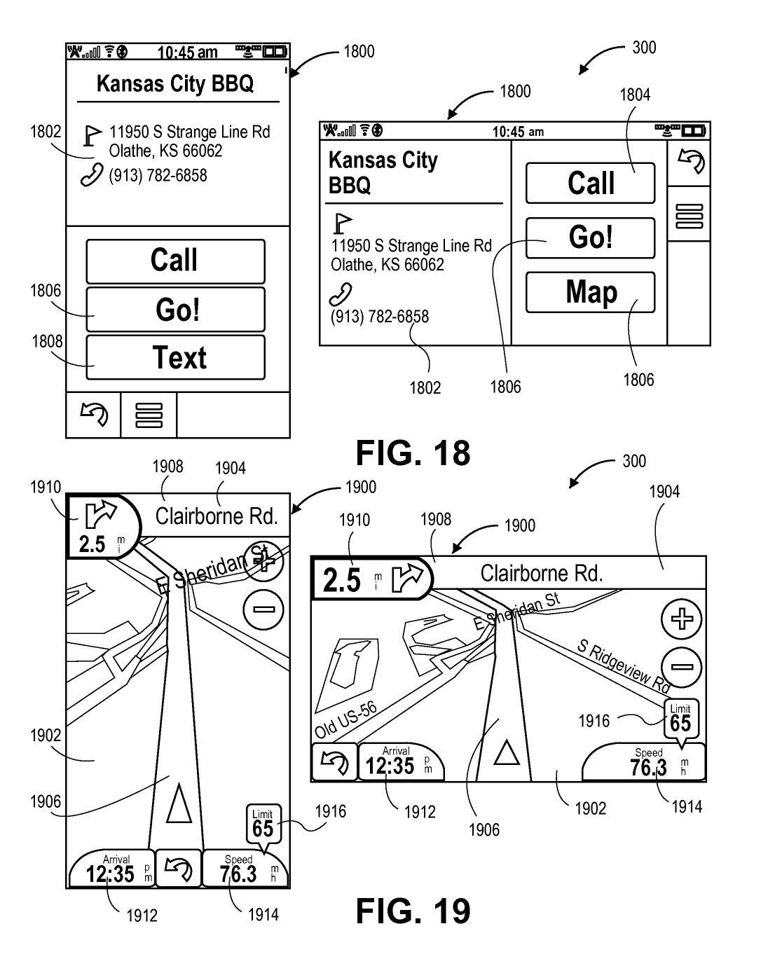

FIG. 18 illustrates submenu screens 1800 of the user interface 300 that provide access to functionality to initiate communication with a party identified as a point of interest from a database of points of interest (POI). POI, which may be arranged in a database stored in memory 106, may comprise a variety of entities, locations, or organizations, such as restaurants, service stations, stores, hotels, parks, airports, schools, places of worship, and the like. As shown, the submenu screens 1800 may include identification information 1802 for the point of interest such as the name of the entity associated with the point of interest, an address associated with the point of interest, a phone number associated with the point of interest, and so on. Button icons may be provided to place a call to the POI 1804, to initiate navigation functionality to navigate to a location associated with the POI 1806, or to initiate functionality to display the POI on a map 1808.

FIG. 19 illustrates submenu screens 1900 of the user interface 300 that provide access to functionality to display a moving map 1902 furnishing navigation information 1904 to a point of interest. In embodiments, navigation information 1904 may include a highlighted route 1906 displayed on the map 1902, turn-by-turn driving directions 1908, distance to the next turn 1910, estimated time of arrival 1912, speed information 1914, speed limit information 1916, and the like.

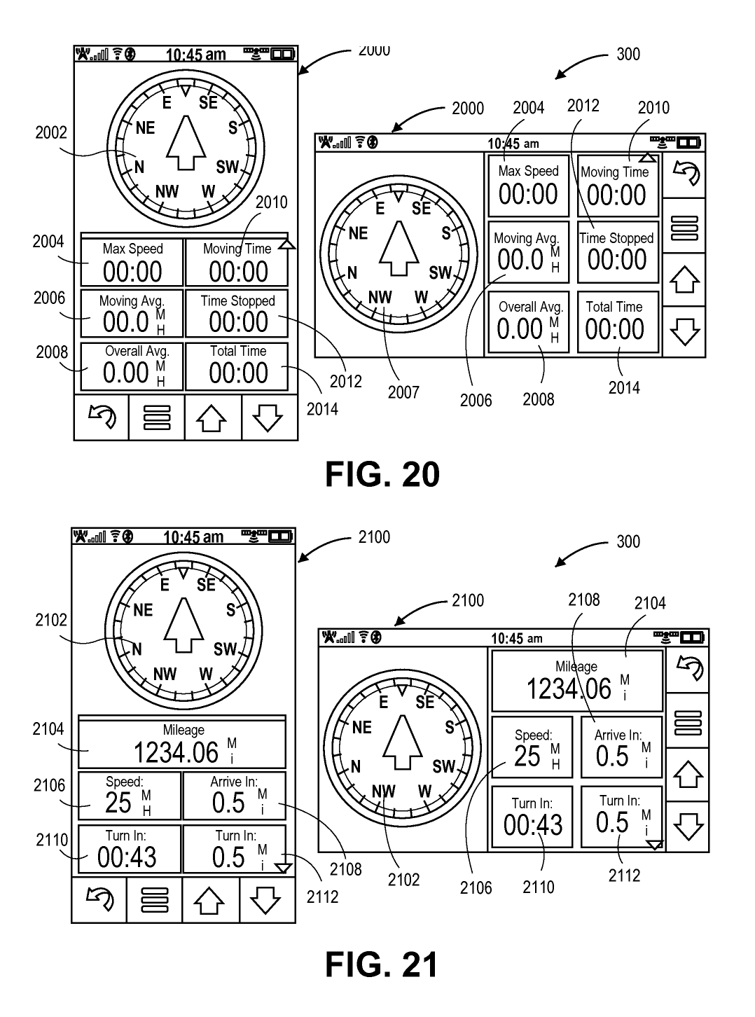

FIG. 20 illustrates submenu screens 2000 of the user interface that provide access to functionality to display information describing movement of the mobile communication device 102. The submenu screens 2000, which may be accessed from the submenu screens 1900 of FIG. 19 when not navigating, may include a compass 2002 and information describing maximum recorded speed 2004, average speed moving 2006, average speed overall (including time while stopped or stationary) 2008, time spent moving 2010, time spend stopped 2012, total time tracked 2014, and so on. Other information may be displayed by scrolling the submenu screens 2000.

FIG. 21 illustrates submenu screens 2100 of the user interface 300 that provide access to functionality to display movement of the mobile communication device 102 during navigation. The submenu screens 2100, which may be accessed from the submenu screens 1900 of FIG. 19 while navigating, may include a compass 2102 and information describing mileage 2104 (e.g., total mileage of the mobile communication device, total mileage for a trip, and so on), speed information 2106, estimated arrival time 2108, time 2110 and distance 2112 to the next turn, and so on. Other information may be displayed by scrolling the submenu screens 2100.

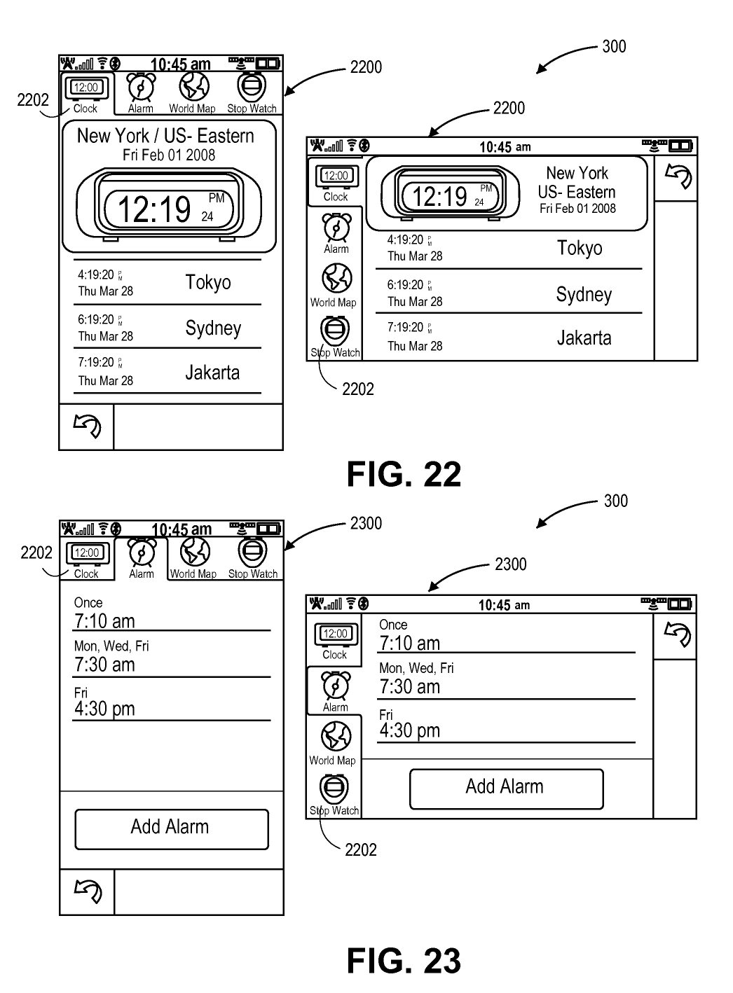

FIGS. 22 through 25 illustrate submenu screens 2200, 2300, 2400, 2500, respectively, of the user interface 300 that provide access to clock functionality. Submenu screens 2200 provide clock functionality and may be configured to display time for a local time zone as well as one or more other time zones. Submenu screens 2300 provide access to alarm clock functionality and allow the user to set one or more alarms. Submenu screens 2400 provide access to functionality to display a geochronic world map 2402. Submenu screens 2500 provide access to stop watch/timer functionality. As shown, a tab graphic 2202 may be employed to furnish navigation between the submenu screens 2200, 2300, 2400, 2500.

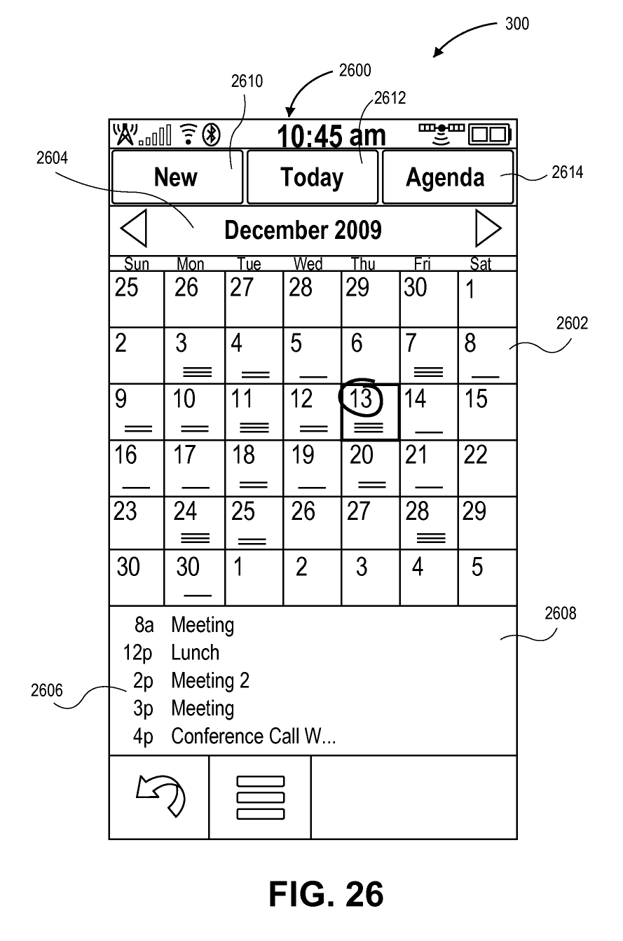

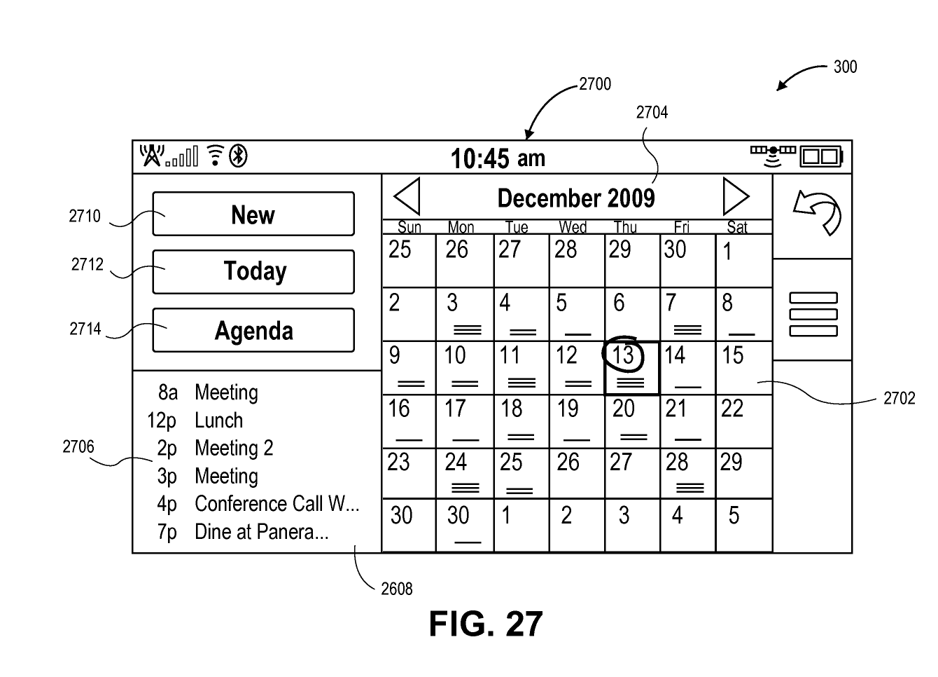

FIGS. 26 and 27 illustrate submenu screens 2600, 2700 of the user interface 300 that provide access to calendar functionality. In FIGS. 26 and 27, the submenu screens 2600, 2700 are illustrated as including a monthly block schedule 2602, 2702 labeled with the corresponding date (month and year) 2604, 2704. In embodiments, calendar entries for a particular day within the block schedule 2602, 2702 may be accessed via a touch input to the touch screen 132 over to that day. The current day may be highlighted (e.g., circled, bolded, shown in a different color, and so forth). Calendar entries 2606, 2706 for the current day are displayed in a list 2608, 2708 positioned adjacent to the monthly block schedule 2602, 2702. Button icons may be furnished to add a new calendar entry 2610, 2710; display a daily calendar for the current date 2612, 2712; and display a daily agenda for the current date 2614, 2714, wherein open time slots (e.g., time slots with no entry) are not shown (see FIG. 29).

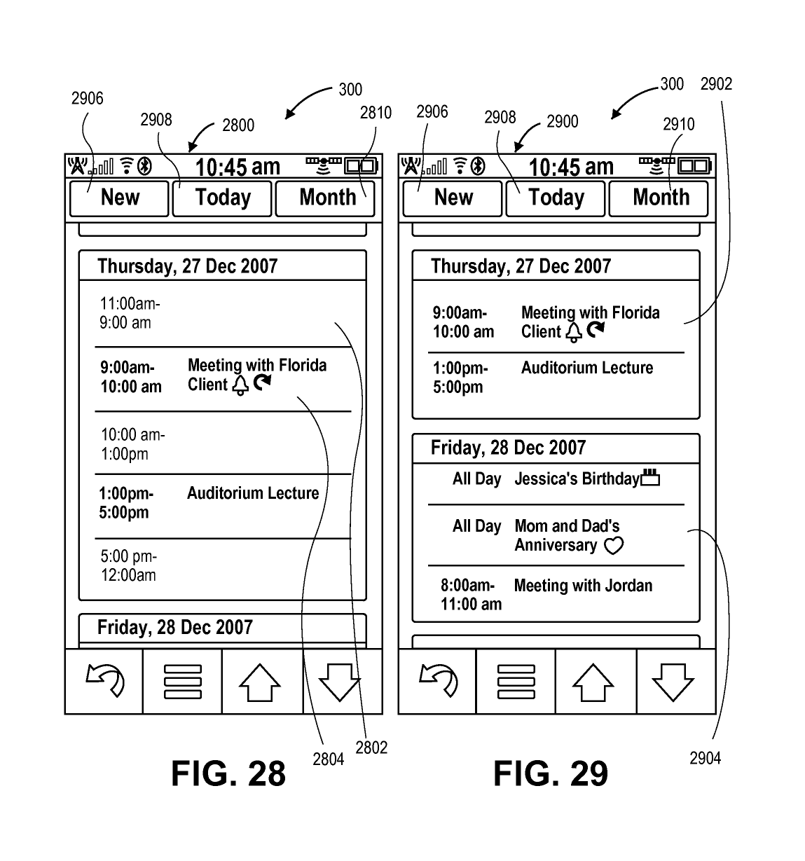

FIGS. 28, 29 and 30 illustrate submenu screens 2800, 2900, 3000 of the user interface 300 that provide access to calendar functionality wherein a weekly calendar 2802, 3002 is provided by submenu screens 2800 and 3000, while a weekly agenda 2902 is provided by submenu screen 2900. As shown, the weekly calendar 2802, 3002 and weekly agenda 2902 may be segmented into day blocks 2804, 2904, 3004 for efficient organization of the information presented. Button icons may be furnished to add a new calendar entry 2806, 2906, 3006; display a daily calendar for the current date 2808, 3008; display a daily agenda for the current date 2908, and display a monthly block schedule (e.g., display monthly block schedules 2602, 2702 of submenu screens 2600, 2700 (FIGS. 26 and 27)).

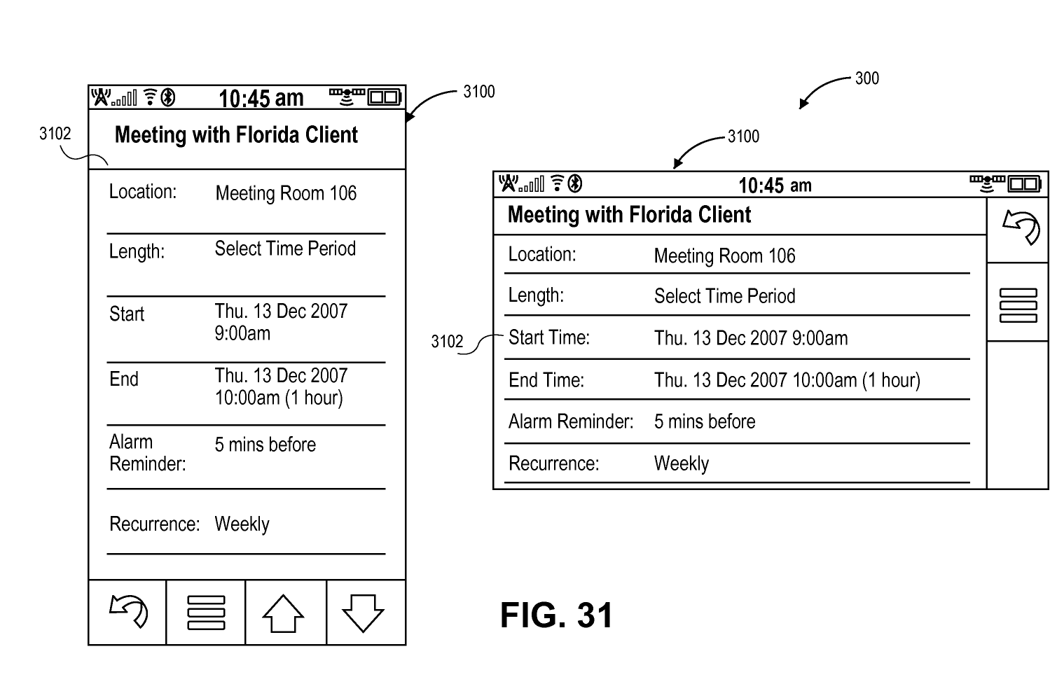

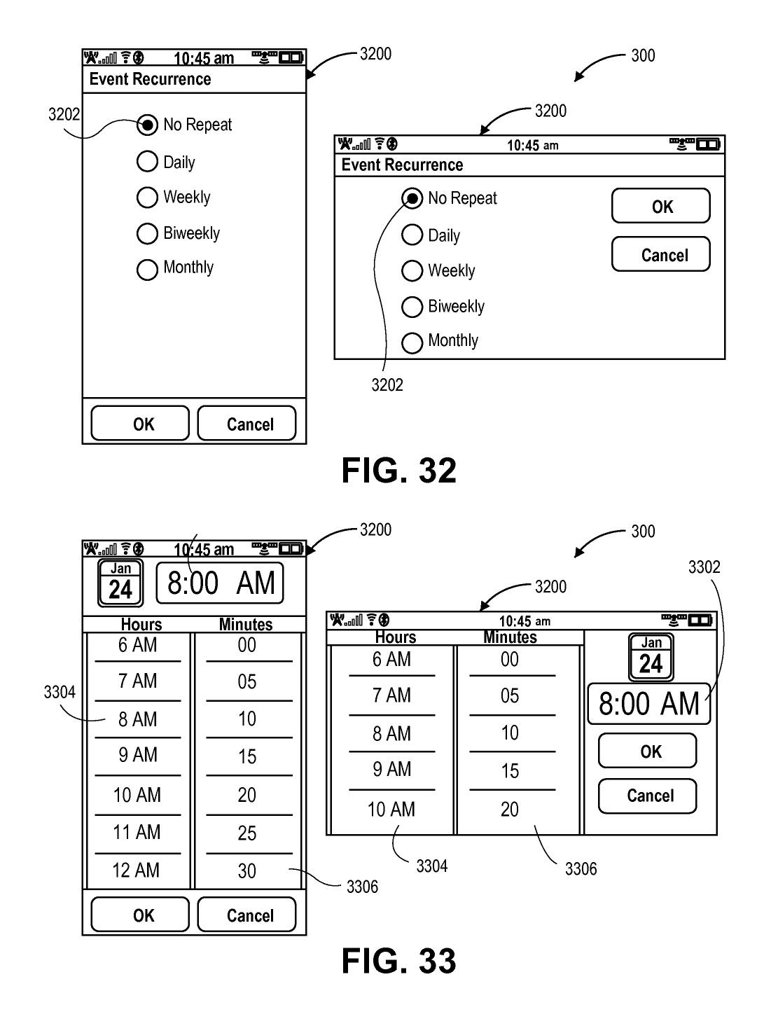

FIG. 31 illustrates submenu screens 3100 of the user interface 300 that provide access to functionality to display and/or set a calendar entry 3102. Information that may be furnished by submenu screens 3100 include a heading (e.g., title) for the calendar entry, a location for the event described by the calendar entry, the length of the event, a start and an end time for the event, an alarm reminder for the calendar entry, an indication of whether the event is a recurring event and the frequency of occurrence, and so forth. FIG. 32 illustrates submenu screens 3200 of the user interface 300 that provide access to functionality to enable recurring calendar entries 3102. As shown, the frequency of occurrence of a calendar entry 3102 (FIG. 31) may be selected as not repeating, a daily occurrence, a weekly occurrence, a biweekly occurrence, or a monthly occurrence by selecting a corresponding radial graphic 3202.

FIG. 33 illustrates submenu screens 3300 of the user interface 300 that provide access to functionality to select a time 3302 for a calendar entry 3102 (FIG. 31). For example submenu screens 3300 may be utilized to select a start and an end time for the event described by the calendar entry 3102. As shown in FIG. 33, a user may scroll a first portion 3304 incremented in hours (e.g., 8 AM, 9 AM, LOAM, and so on) to select an hour for the event to start/end. The user may then scroll a second portion 3306 incremented in five (5) minute intervals (e.g., 00, 05, 10, 15, 20, 30, and so on) to select a minute for the event to start/end.

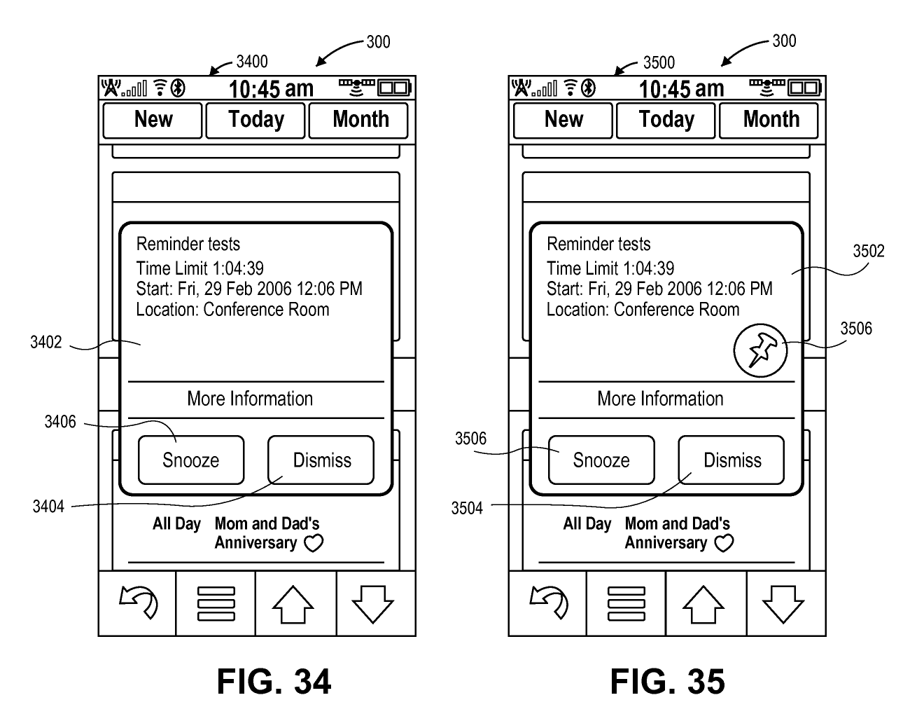

FIGS. 34 and 35 illustrate submenu screens 3400, 3500 of the user interface 300 that provide access to functionality to display a popup reminder 3402, 3502 for a calendar entry 3102 (FIG. 31). As shown, the popup reminder 3402, 3502 may include button icons to dismiss the reminder 3404, 3505, or to delay (e.g., “snooze”) the reminder for a duration of time (e.g., 5 minutes, 1 hour, 1 day, and so on) 3406, 3506. In FIG. 35, the popup reminder 3502 may further include a pin graphic 3508 that provides additional information to a user of the mobile communication device 102, such as searchable information about the event or available navigation/map information for the event (e.g., travel time to reach the location of the event described by the calendar entry, or a route to the event, and so forth). Other information may be furnished.

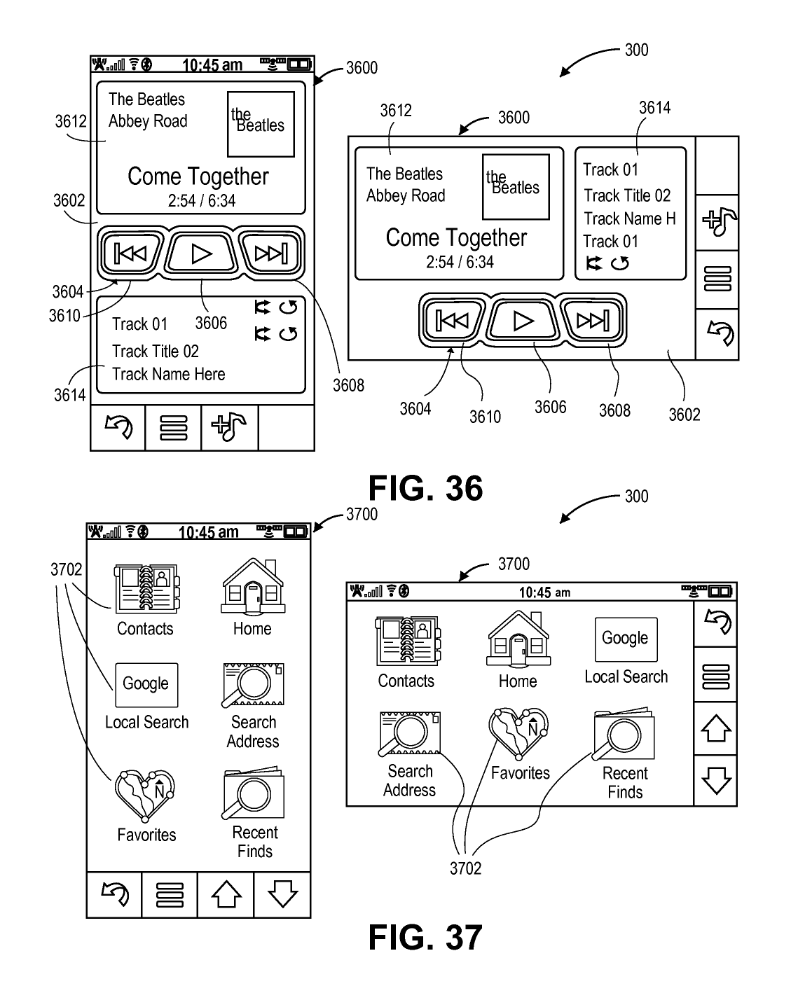

FIG. 36 illustrates submenu screens 3600 of the user interface 300 that provide access to functionality to provide playback of stored media. In embodiments, a wide variety of media may be played by the mobile communication device 102. Such media may include, but is not limited to, audio (e.g., audio files having formats such as MP3, MP4, WAV, and so on) and/or video (e.g., video files having formats such as MPEG, M-JPEG, and so on). Such media may be received over network 110, for example, as content 118 received from Internet provider 114 and stored in memory 106. In FIG. 36, the submenu screens 3600 are illustrated as implementing a media player 3602 that includes media playback controls 3604 implemented as button icons such as play 3606, fast forward/skip 3608, and rewind/replay 3610. The media player 3602 may further provide information about the media file being played 3612, such as the title of the media, the artist recording the media, album title, album artwork, and so on. Information describing playback of the media file 3614 may also be furnished.

FIG. 37 illustrates submenu screens 3700 of the user interface 300 that provide access to search functionality. As shown, submenu screens 3700 may include a variety of icons 3702 that provide access to searching functionality to search for information from multiple sources. A variety of information may be accessed through icons 3702. For example, icons 3702 may provide access to navigation/mapping functionality as well as other information, including POI information, telephone number information, webpage information, email address information, and so forth.

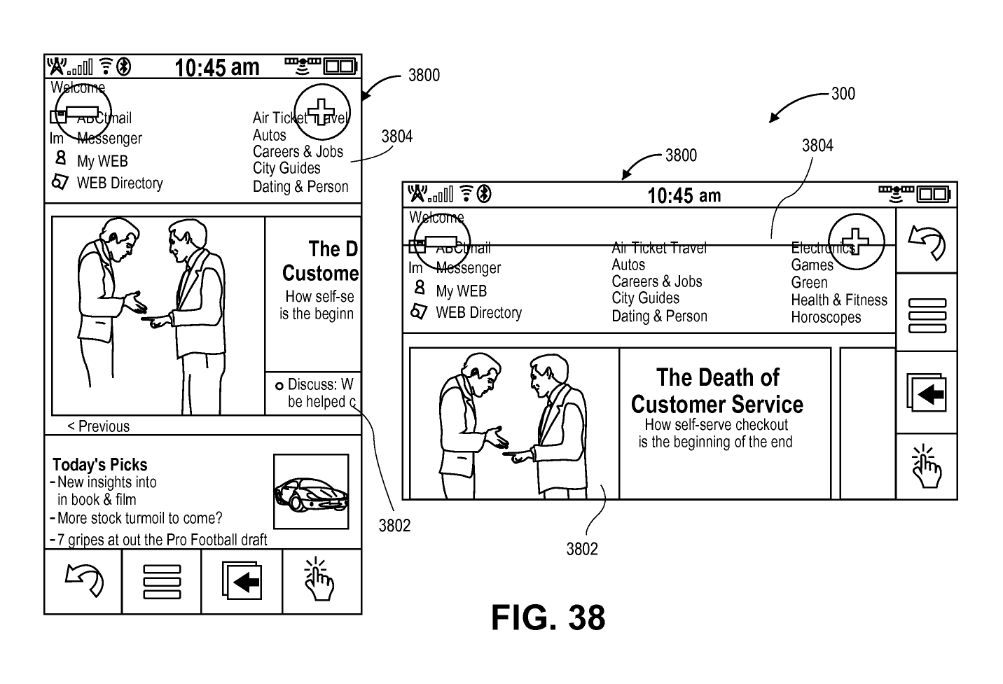

FIG. 38 illustrates submenu screens 3800 of the user interface 300 that provide access to Internet browsing functionality. Submenu screens 3800 may access a mobile browser application that causes content 118 received from an Internet provider 114 via one or more networks 110 to be furnished to a user of the mobile communication device 102. As shown, submenu screens 3800 may include content display areas 3802 for displaying content 118 and a navigation area 3804 providing access to Internet email functionality, Internet messaging functionality, Internet search functionality, social networking functionality, and so on.

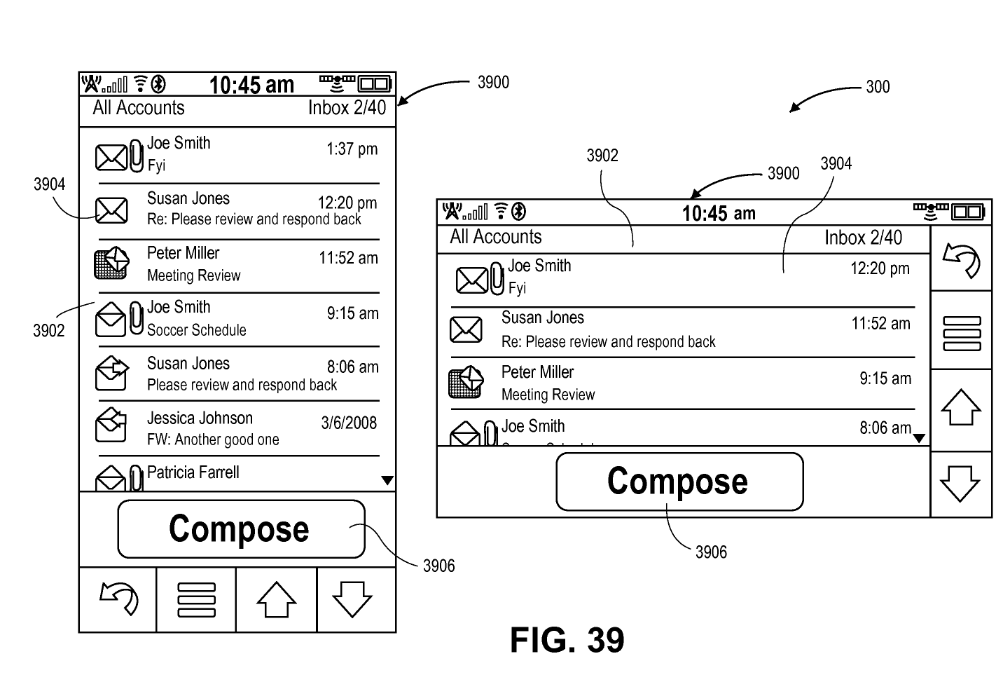

FIG. 39 illustrates submenu screens 3900 of the user interface 300 that provide access to functionality to send and receive messages. In the embodiment illustrated, such messages comprise email messages. However, messages that may be sent and received by the mobile communication device 102 may also include SMS text messages, MMS text messages, social network messages, meeting invitations, and so forth. As shown, submenus screens 3900 are illustrated as including an inbox (or, selectably, an outbox, a sent messages list, a combination thereof, and the like) 3902 that displays summary information for received messages 3904. A button icon (“Compose”) 3906 is furnished to initiate functionality to compose a message.

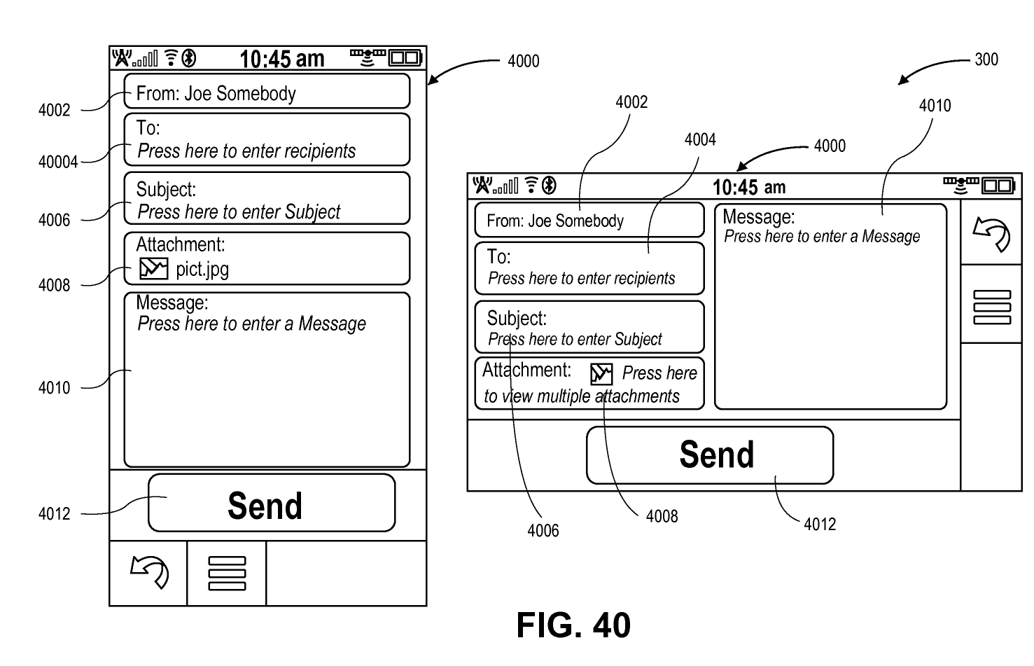

FIG. 40 illustrates submenu screens 4000 of the user interface 300 that provide access to functionality to compose a message. In embodiments, submenu screens 400 may be accessed when a user of the mobile communication device 102 selects the Compose button icon 3906 of the submenu screens 3900 of FIG. 39. As shown, submenu screens 4000 includes a field configured to receive entry of the identity (e.g., email address) of the sender (i.e., a user of the mobile communication device) 4002. It is contemplated that mobile communication device 102 may support the use of multiple messaging accounts. Thus, the user may enter or select an identity (e.g., an email address) for entry into field 4002 that corresponds to a desired messaging service and/or account from which the message is to be sent. Submenu screens 4000 may further include fields configured to receive the identity (e.g., email address, name, username, screen name, etc.) of the recipient of the message 4004, the subject of the message 4006, attachments 4008, and the body of the message 4010. A button icon (“Send”) is furnished to initiate functionality to send the message 4012.

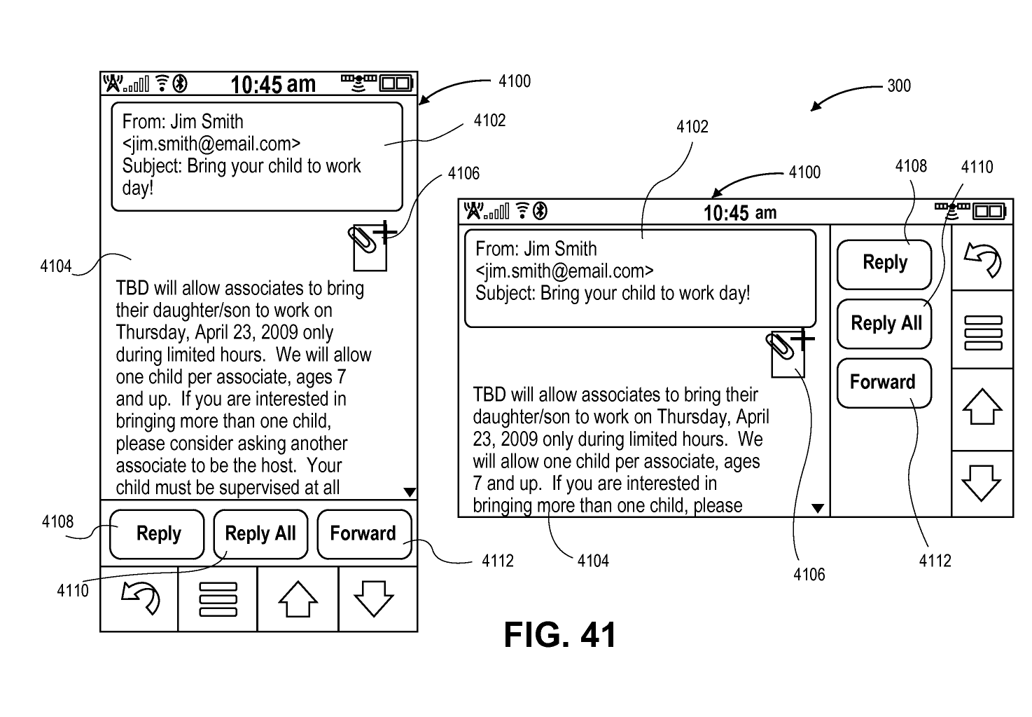

FIG. 41 illustrates submenu screens 4100 of the user interface 300 that provide access to functionality to display a received message. As shown, submenu screens 4100 include display areas to furnish heading information (e.g., the sender's identity, the subject, the identity of other recipients, and so on) of the received message 4102, the content of the message 4104 and an attachment icon 4106 to access an attachment if an attachment is included with the message. Button icons are furnished to initiate functionality to reply to the sender of the received message 4108, reply to all recipients of the received message 4110, or forward the message to a new recipient 4112.

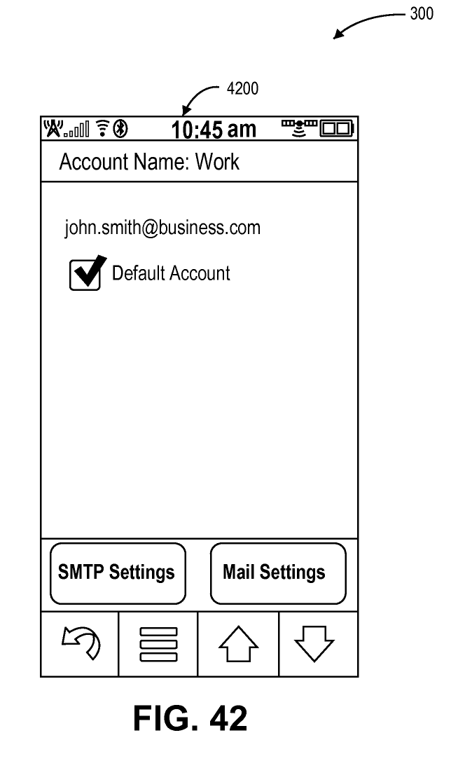

As noted, it is contemplated that mobile communication device 102 may support the use of multiple messaging accounts such as multiple email accounts. FIG. 42 illustrates submenu screens 4200 of the user interface 300 generated that provide access to functionality to enter settings for an email account. In particular, submenu screen 4200 allows a user to select an email account as a default email account for use by the mobile communication device 102.

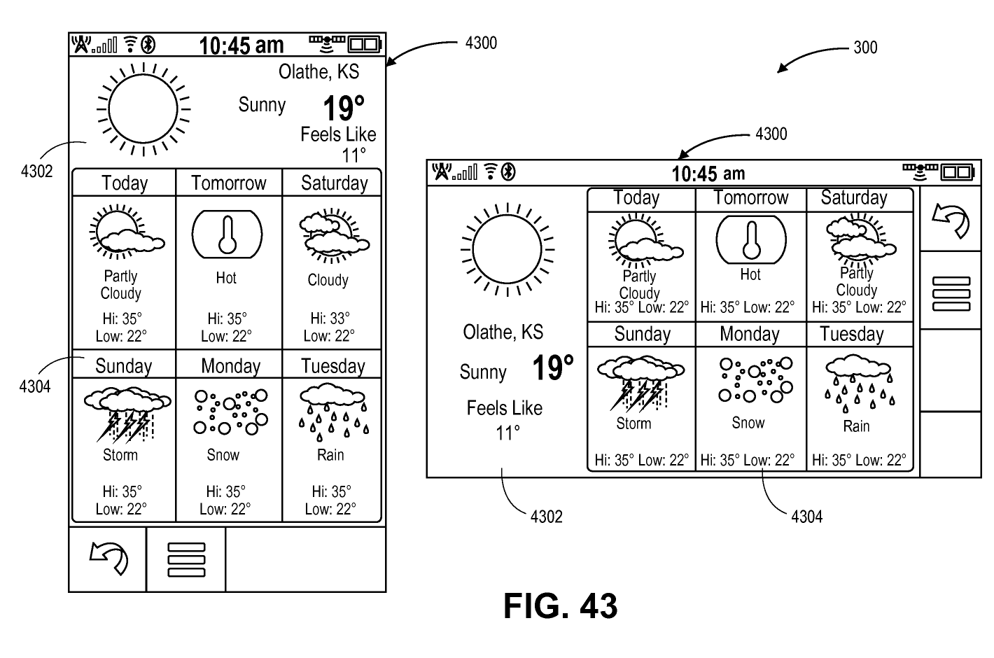

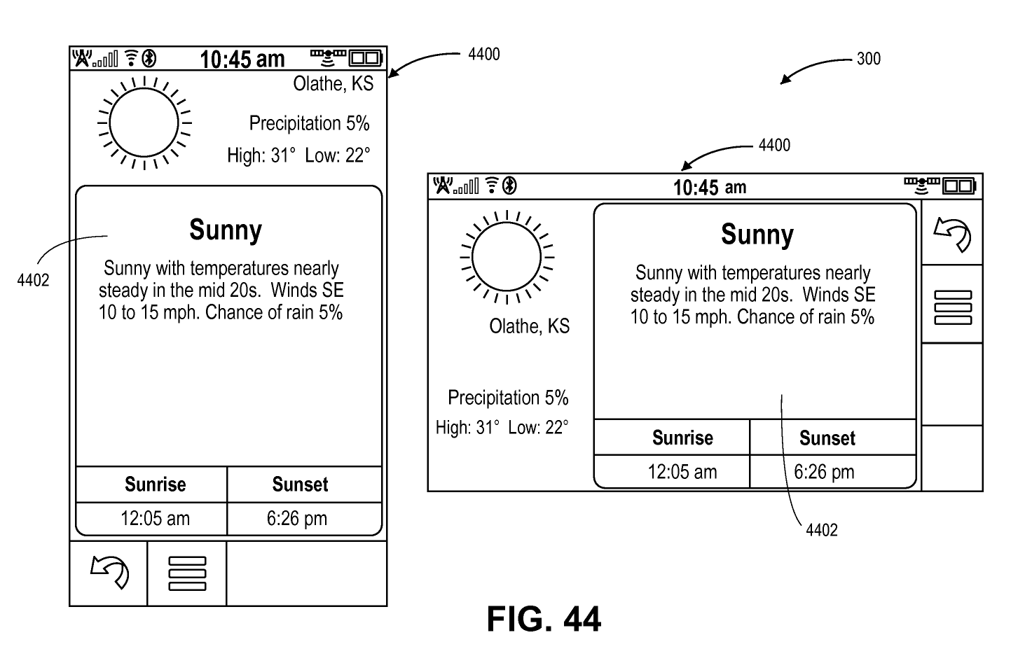

FIGS. 43 and 44 illustrate submenu screens 4300, 4400 of the user interface 300 that provide access to functionality to display weather information. As shown, submenu screens 4300 display current weather conditions for the local area in which the mobile communication device 102 located 4302 and summary forecasts of future weather conditions for the area 4304. Submenu screens 4400 display detailed forecast information 4400 for a particular day selected from the summary forecasts 4304 of submenu screen 4300. In embodiments, the location of the mobile communication device may be determined by the position-determining module 120, or may be entered by a user of the mobile communication device 102. In embodiments, weather information may be received over network 110, for example, as content 118 received from Internet provider 114 and stored in memory 106.

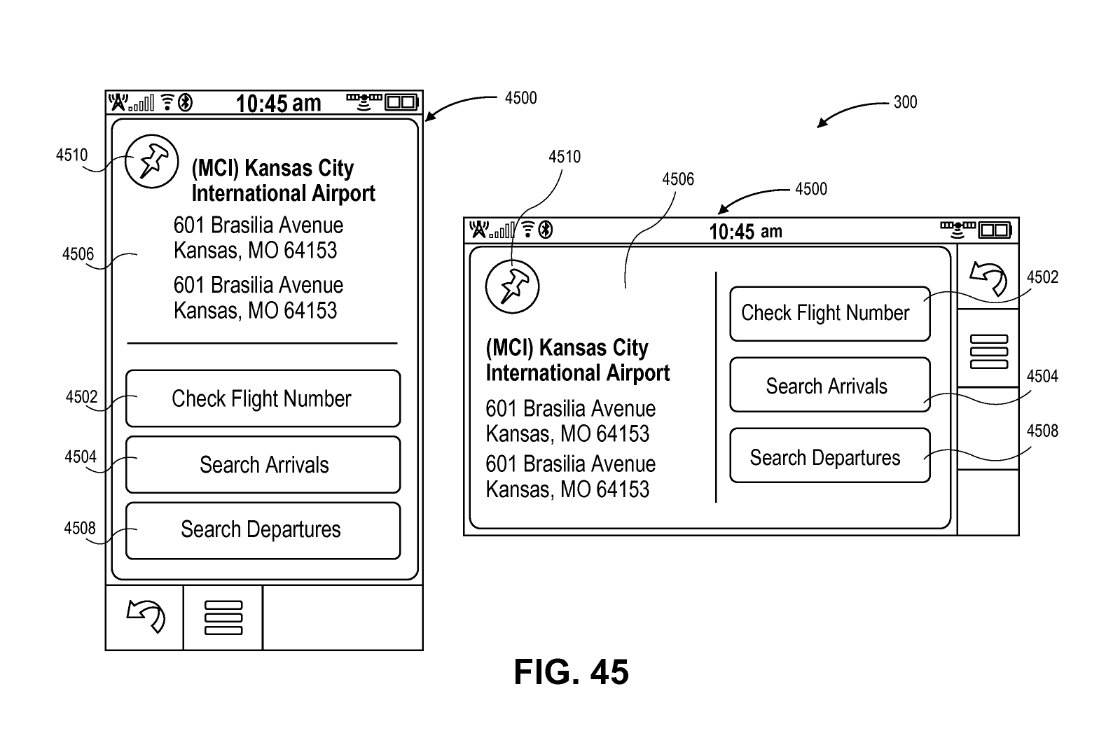

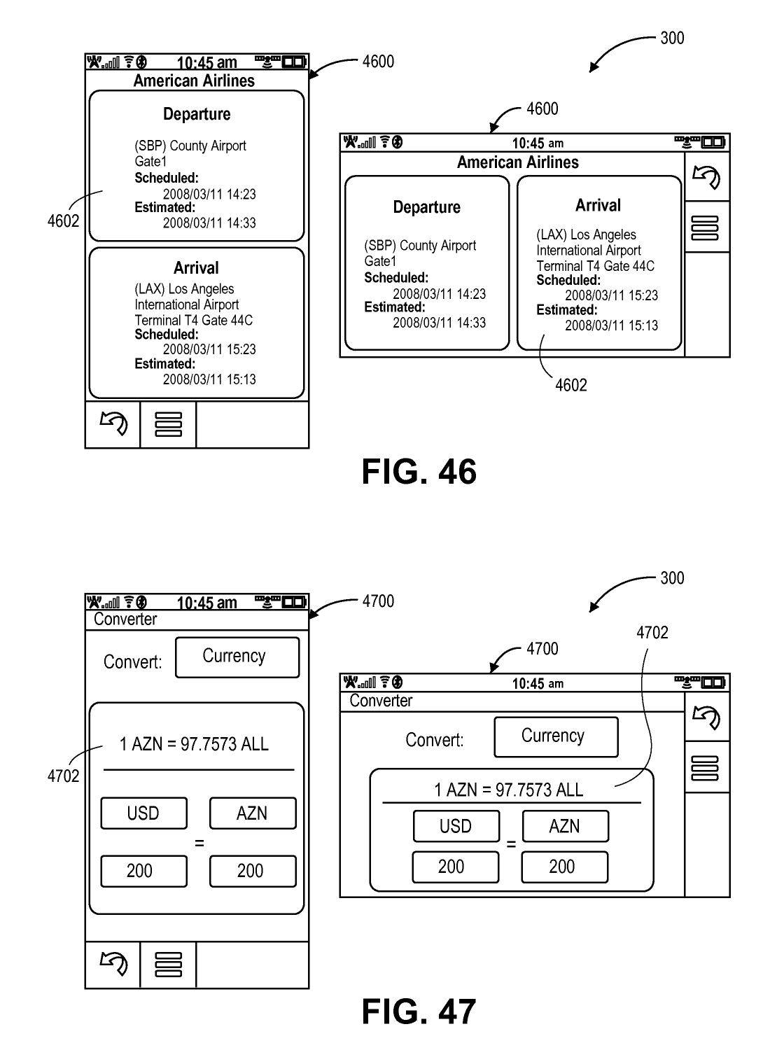

FIGS. 45 and 46 illustrate submenu screens 4500, 4600 of the user interface 300 that provide access to functionality to display airport flight information. As shown in FIG. 45, submenu screens 4500 may include button icons that access functionality to check the status of a particular flight identified by flight number 4502, search for all arrivals 4504 of an identified airport 4506, or search for all departures 4508 of the airport 4506. A pin graphic 4510 provides additional information to a user of the mobile communication device 102, such as searchable information about the airport or available navigation/map information for the airport (e.g., travel time to reach the airport, a route to the airport, and so forth). Other information may be furnished. As shown in FIG. 46, submenu screens 4600 provide access to functionality to display flight information for a particular flight 4602.

FIGS. 47, 48 and 49 illustrate submenu screens 4700, 4800, 4900 of the user interface 300 that provide access to functionality to provide currency conversion. As shown, submenu screens 4700 allow a user to select the currencies to be converted. Submenu screens 4700 may display an exchange rate 4702 for the currencies selected. In embodiments, the exchange rate information may be received over network 110, for example, as content 118 received from Internet provider 114 and stored in memory 106. Submenu screens 4800, 4900 provide access to functionality to provide entry of currency conversion information.

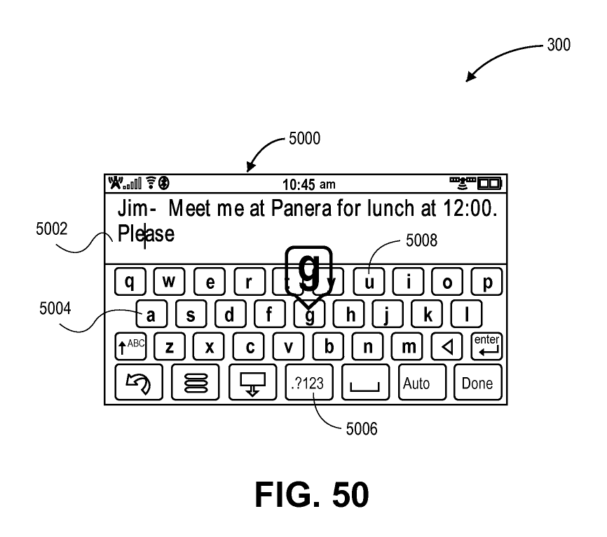

FIG. 50 illustrates submenu screen 5000 of the user interface 300 generated that provides access to functionality to enter alphanumeric information. As shown, submenu screen 5000 includes a text entry field 5002 and a keyboard 5004. In embodiments, keyboard 5004 may be a QWERTY keyboard providing alphabetic keys. A numeric toggle key 5006 may be provided to allow input of number and non-alphabetic characters. However, keyboard 5004 may also comprise keys arranged generally in alphabetical/numeric order.

Selection (e.g., pressing) of keys 5008 of keyboard 5004 may be indicated to the user to allow the user to verify key selection. Indication of key selection may be provided in a variety of ways. For example, in the illustrated embodiment, the user interface 300 may cause a graphic element (e.g., bubble graphic 5010) to be displayed adjacent to (e.g., above) a selected key 5008 upon selection of the key 5008 by a user touching the touch screen 132 over the key 508. The bubble graphic 5010 may contain the letter of the selected key 5008, and may be visible to the user adjacent to his or her fingertip. Indication of key selection may also be provided in other ways, such as by momentarily changing the color and/or brightness of the selected key 5008, and so forth.

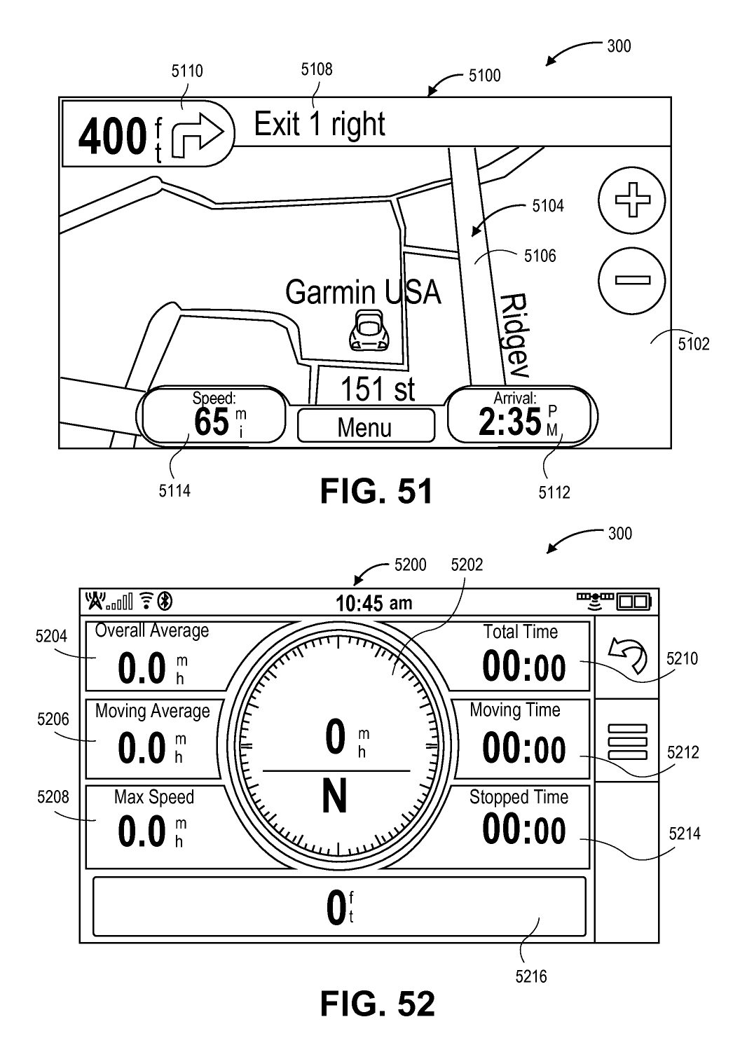

FIG. 51 illustrates a submenu screen 5100 of the user interface 300 that provides access to functionality to display navigation information for an automobile. As shown, submenu screen 5100 includes a moving map 5102 which may be configured to furnish navigation information 5104 to a point of interest. In embodiments, navigation information 5104 may include a highlighted route 5106 displayed on the map 5102, turn-by-turn driving directions 5108, distance to the next turn and the direction of the turn 5110, estimated time of arrival 5112, speed information 5114, and so forth.

FIG. 52 illustrates a submenu screen 5200 of the user interface 300 that provides access to functionality to display travel information. As shown, the submenu screen 5200 may include a compass/heading indicator 5202 and information describing average speed overall (including time while stopped or stationary) 5204, average speed moving 5206, maximum recorded speed 5208, total time tracked 5210, time spent moving 5212, time spent stopped 5214, and so on. Distance and direction to the next turn may also be displayed.

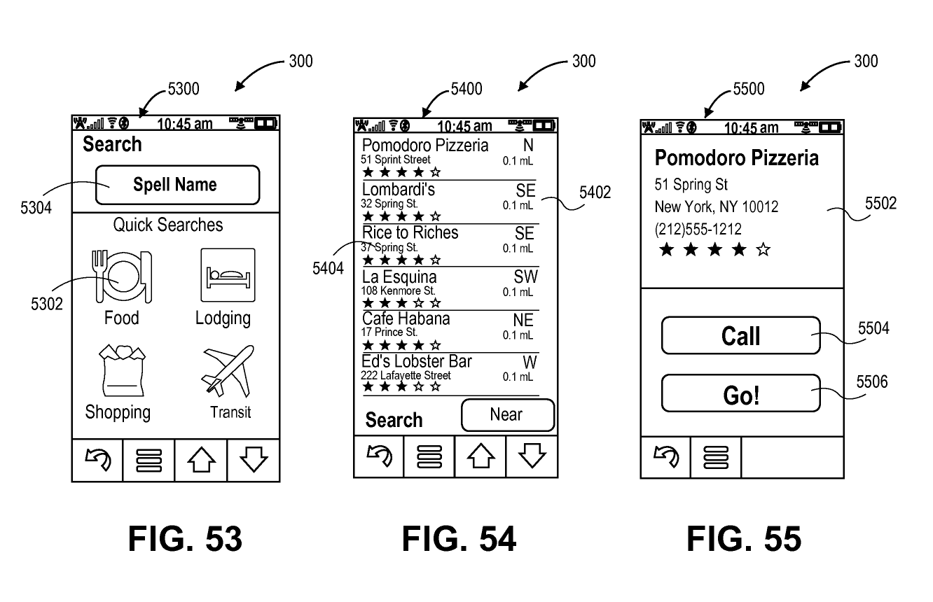

FIGS. 53, 54, and 55 illustrate submenu screens 5300, 5400, 5500 of the user interface 300 that provide access to functionality to select a point-of-interest (POI) from a point of interest database. In embodiments, the POI database may be stored in memory 106 of the mobile communication device 102 and/or accessed as content 118 received from Internet provider 114. For example, POI information may be accessed via an Internet search engine. As shown, submenu screen 5300 may be configured to include a variety of icons 5302 that provide access to functionality to categorize the POI information (e.g., POI information may be categorized under categories such as food (e.g., restaurants), lodging, shopping transit, and so forth, each represented by an icon 5302. A button icon (“Spell Name”) 5304 may be provided to allow the user to enter the name of a desired POI or a search term.

A variety of information may be accessed through icons 5302. For example, POI information accessed through icons 5302 may include navigation/mapping information enabling navigation/mapping functionality, telephone number information, webpage information, email address information, user ranking/evaluation information, and so forth. For instance, in response to selection of an icon 5302 from submenu screen 5300, the user interface 300 may access functionality to cause a listing of POI information 5402 in the selected category to be displayed in submenu screen 5400 of FIG. 54. In embodiments, POIs 5404 of the listing of POI information 5402 may include the name of the entity associated with the POI, the address of the POI, a telephone number for the entity associated with the POI, user ranking/evaluation information associated with the POI, the approximate distance and direction to the POI, and so forth. A POI 5404 may then be selected from the listing 5402 by a user of the mobile communication device 102.

Submenu screen 5500 displays information for a selected POI that may be used to facilitate calling and/or navigating to the POI selected. As shown, submenu screen 5500 includes button icons to initiate functionality to call the entity associated with the POI 5502 and/or to provide navigation information to navigate to the POI 5504. In embodiments, navigation information to the selected POI may be displayed via a moving map 5102 provided by submenu screen 5100 of FIG. 51.

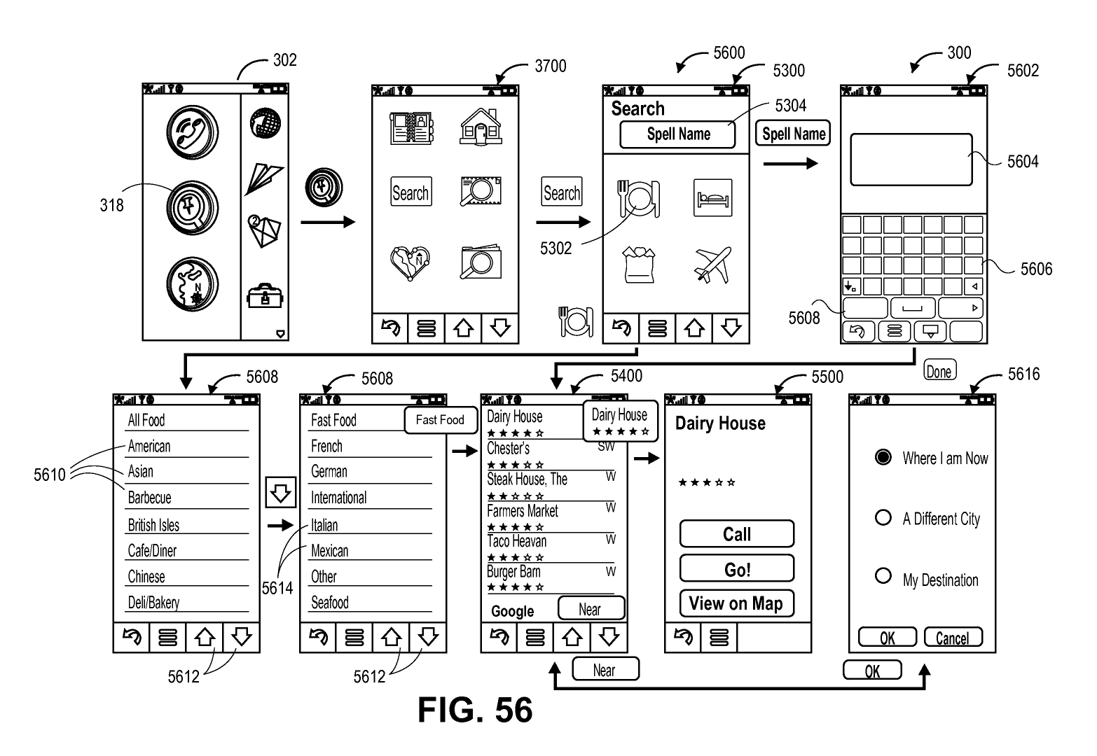

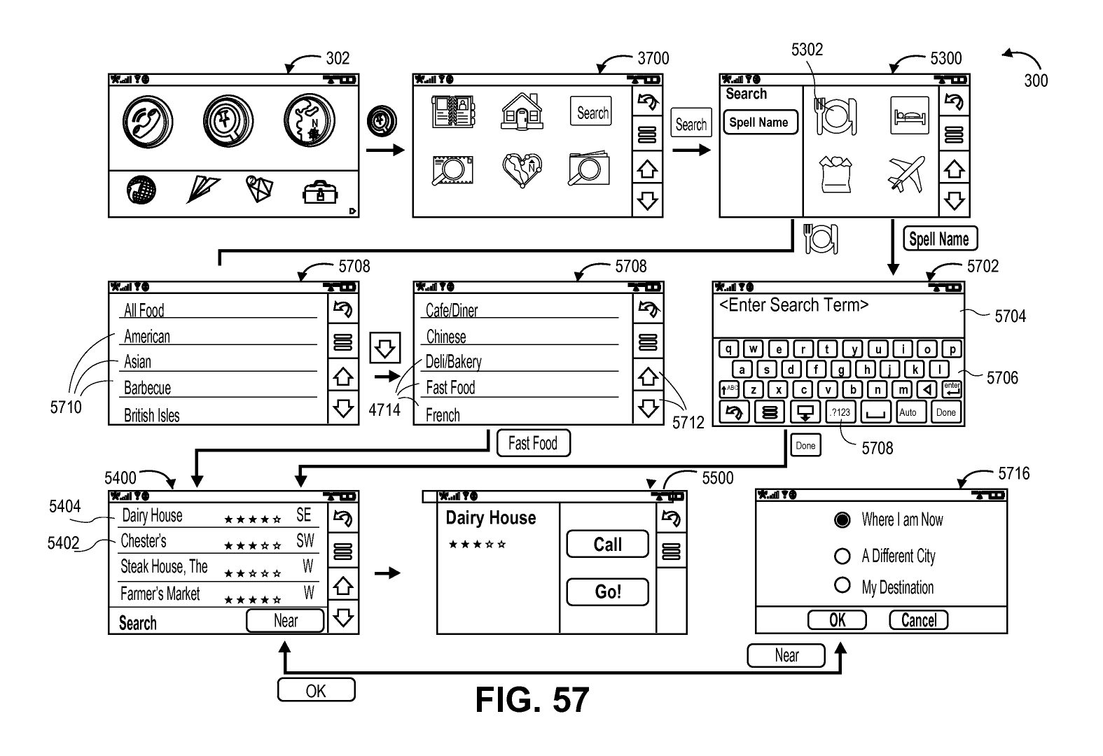

FIGS. 56 and 57 illustrate a progression of submenu screens 5600, 5700 of the user interface 300 that provide access to functionality to select a POI. As shown, the search icon 318 is selected from the main menu screen 302 to initiate the POI search. Selection of the search icon 318 causes the user interface 300 to display submenu screen 3700 exposing search icons 3702 to the user. A local search icon 3702 may then be selected, causing the user interface 300 to display submenu screen 5300.

The POI may be selected by entering a search term (e.g., a word, a phrase, a group of words, or the like) related to the POI. From submenu screen 5300, the user may then select the “Spell Name” button icon 5304 to cause the user interface 300 to display a submenu screen 5602, 5702 that facilitates entry of the search term. As shown, submenu screen 5602, 5702 includes a text entry field 5604, 5704 and a keyboard 5606, 5706. In FIG. 56, the keyboard 5606 is illustrated as comprising keys arranged generally in alphabetical order; while in FIG. 57, the keyboard 5706 is illustrated as being a QWERTY keyboard providing alphabetic keys. A numeric toggle key 5608, 5708 may be provided to allow input of number and non-alphabetic characters. The search term may then be entered by typing the search term into the text entry field 5604, 5704 via the keyboard 5606, 5706. The user interface 300 may then cause a listing of POI information 5402 to be displayed in submenu screen 5400. A POI 5404 may be selected from the listing 5402 by a user of the mobile communication device 102, causing the user interface 300 to display submenu screen 5500. As shown, submenu screen 5500 displays information for the selected POI that may be used to facilitate calling and/or navigating to the selected POI.

The POI may also be selected using a category search. As shown, submenu screen 5300 includes a variety of icons 5302 that provide access to functionality to group the POI information into categories such as food (e.g., restaurants), lodging, shopping transit, and so forth, each represented by an icon 5302. The user may select an icon 5302 causing submenu screen 5608, 5708 to be displayed to provide additional subcategories 5610, 5710 from which a desired POI may be selected. In some instances, a scroll button icon 5612, 5712 may be selected to access additional categories 5614, 5714 within submenu screen 5608, 5708. The user interface 300 may then cause a listing of POI information 5402 to be displayed in submenu screen 5400. A POI 5404 be selected from the listing 5402 by a user of the mobile communication device 102, causing the user interface 300 to display submenu screen 5500. In one or more embodiments, submenu screen 5300 may further include a button icon 5616, 5716 that permits the user to select the location of POIs to be displayed (e.g., the user's current location, a different city, a destination).

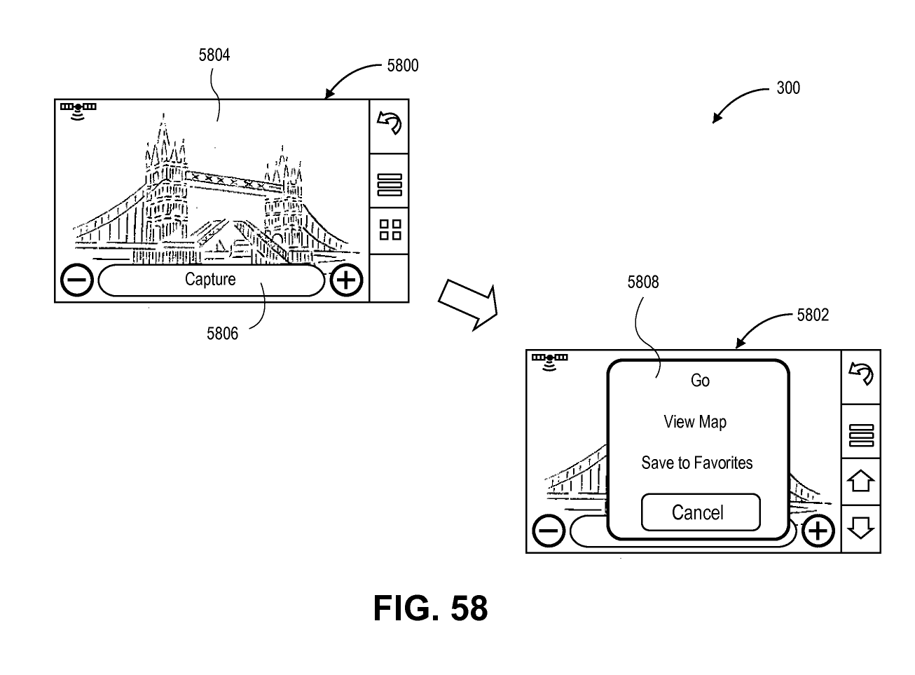

As noted, the mobile communication device 102 of FIG. 1 may be provided with a camera 138 to capture digital image media, which may be stored in memory 106. FIG. 58 illustrates submenu screens 5800, 5802 of the user interface 300 that provide access to functionality to capture, store and/or geocode digital image media using the camera 138. As show, submenu screen 5800 includes a displayed image to be captured (e.g., as a still photograph, as a video, and so forth). A button icon (“Capture”) 5804 may be selected, via touch input to the touch screen 132 or depression of another I/O device button of the mobile communication device 102 (e.g., a camera button). The captured image may then be stored to memory 106 as a digital image media file. Exif data may be stored with the file to provide metadata about the image captured. For example, Exif data may include the date and time the image media was captured, the location where the media was captured determined by the position-determining module 120, and the like.

The digital image media file may be displayed by display device 130 and/or transmitted to other devices via a network 110 (e.g. via an email or MMS text message). Location information stored as Exif data may also be used for navigation. Thus, as shown in FIG. 58, submenu screen 5802 displays a popup menu 5808 that provides access to functionality to display a map of the area surrounding the location where the image was captured, and/or navigate to this location.

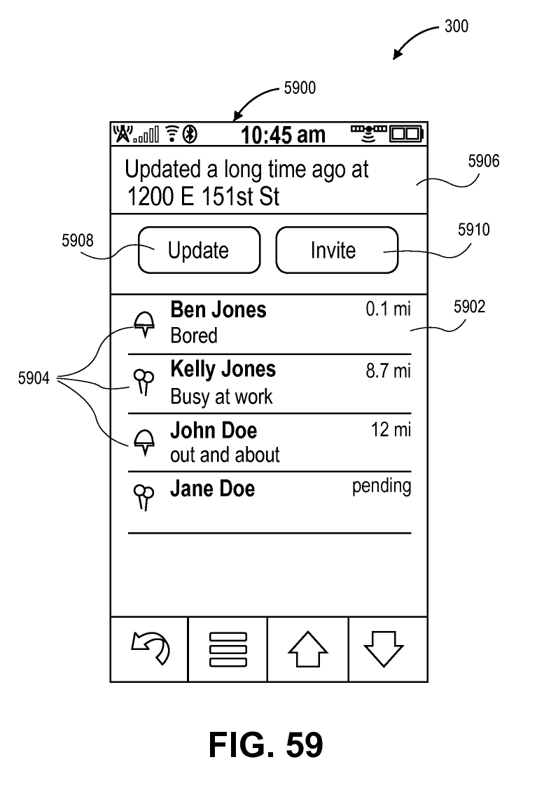

FIGS. 59, 60, 61 and 62 illustrate submenu screens 5900, 6000, 6100, 6200 of the user interface 300 provide access to social networking and or friend finding functionality. Submenu screen 5900 may include a friend list 5902 containing a list of entries 5904 corresponding to the user's friends sorted based on the distance of the friends from the user (e.g., the distance the friends are from the mobile communication device 102). Entries 5904 within the friend list 5902 may provide a variety of information related to the identity and/or status of the friends represented. For example, entries 5904 within the friend list 5902 may indicate the name of the friend, the distance of the friend from the user, the friend finding service the friend is using (e.g., via a network icon configured to identify the network), and the status of the friend (e.g. “Bored” or “Busy at work”). Other information may be furnished by the friend list 5902. Submenu screen 5900 may further display the update status of the user (e.g., the last time the displayed information was updated by the service) 5906. Button icons allow the user to update the displayed friend information 5908, to invite new friends 5910, and so forth.

Submenu screen 6000 provides access to functionality that allows a user of the mobile communication device to remove a friend from the friend list 5902 of submenu screen 5900. In embodiments, submenu screen 6000 may include a status field 6002 that displays information such as the current status of the friend (e.g., “Mike has not accepted your invitation yet”) and the friend finding service the friend is using (e.g., “Buddy Beacon”). A button icon (e.g., “Remove”) 6004 is provided to receive input to remove the friend.

A user may select an entry 5904 from friend list 5902 to display additional information describing the status of the friend. Submenu screen 6100 may then be displayed by the user interface 300 to display this information. As shown, submenu 6100 includes a status field 6102 that is configured to display information for the friend such as the friend's identity (e.g., name, screen name, username, and so on), status, address, friend finding system, and so forth. Submenu screen 6100 further includes button icons to initiate functionality to display a map of the area in which the friend is located 6104 and/or to provide navigation information to navigate to the friend's location 6106. A status bar 6108 furnishes the update status of the displayed information for the friend.

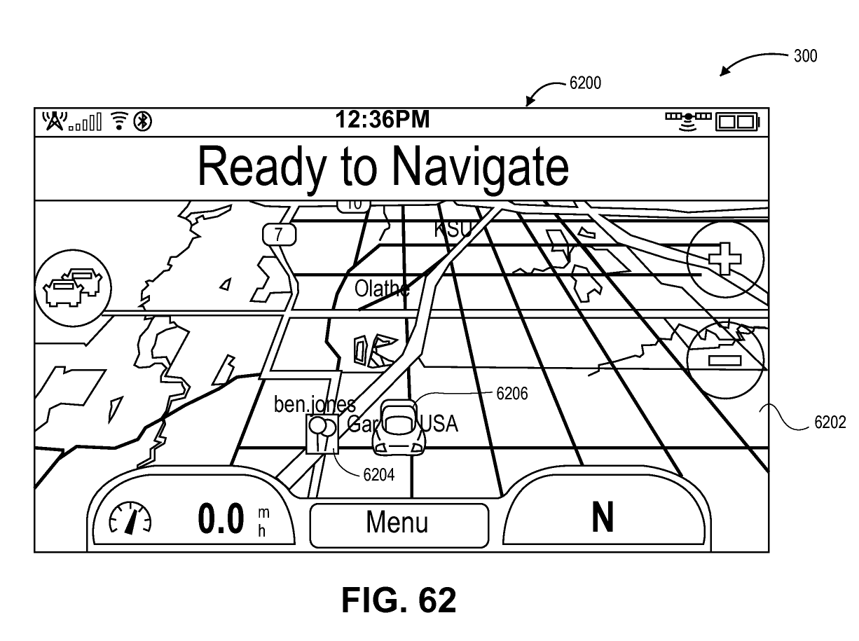

In embodiments, navigation information to the friend may be displayed via a moving map 6202 provided by submenu 6200 of FIG. 62. The location of friends may be displayed on the map display 6202 as a friend icon 6204. The location of the user may similarly be displayed as a user icon 6206 such as an automobile graphic, an arrow, and so forth. As the user moves about, the moving map display 6202 may change to reflect the user's changed location, and the location of nearby friends may be automatically displayed as friend icons 6204 displayed on the map display 6202. Similarly, as nearby friends of the user move about and new location information is received, the positions of friend icons 6204 representing those friends within the map display 6202 may change to reflect the changed locations of the friends.

The main menu screen 302 and/or the submenu screens 500-6200 of the user interface 300 may present day and night modes, wherein a lighter background is employed while the day mode is active (e.g., during daytime) and a darker background is employed while the night mode is active (e.g., during nighttime). Additionally, the main menu screen 302 and/or the submenu screens 500-620 may include a status bar 338 that is configured to display status information for the mobile communication device 102, a navigation bar that facilitates navigation between submenu screens, and so on. In embodiments, status information furnished by the status bar 338 may include, but is not limited to, the current time, cellular network signal strength, BLUETOOTH availability WIFI availability and signal strength, GPS signal availability, remaining battery life, and so on.

### CONCLUSION

Although techniques to provide a user interface for a display of a mobile communication device have been described in language specific to structural features and/or methodological acts, it is to be understood that the appended claims are not necessarily limited to the specific features or acts described. Rather, the specific features and acts are disclosed as exemplary forms of implementing the claimed devices and techniques.

What is claimed is:

1. A method comprising:
causing a display device of a mobile communication device to display a user interface including a main menu having a fixed portion and a movable portion, the fixed portion including primary icons associated with primary functions of the mobile communication device and the movable portion including secondary icons associated with secondary functions of the mobile communication device;
receiving a first input via a touch interface of the display device to scroll the secondary icons within the movable portion;
causing the secondary icons to scroll within the movable portion while the primary icons remain stationary within the fixed portion in response to the first input; and
receiving a second input via the touch interface to select a secondary icon from the movable portion to access a secondary function of the mobile communication device.

2. The method as recited in claim 1, further comprising:
determining an orientation of the mobile communication device; and
causing the user interface to be displayed in one of a portrait mode or a landscape mode in response to the determined orientation.

3. The method as recited in claim 2, wherein the movable portion is positioned to a side of the fixed portion when the user interface is displayed in the portrait mode, the secondary icons being aligned vertically and scrolling in a vertical direction.

4. The method as recited in claim 2, wherein the movable portion is positioned below the fixed portion when the user interface is displayed in the landscape mode, the secondary icons being aligned horizontally and scrolling in a horizontal direction.

5. The method as recited in claim 2, wherein the primary icons are displayed in a vertical arrangement within the fixed portion when the user interface is displayed in the portrait mode, the primary icons remaining fixed with respect to the display during scrolling of the secondary icons.

6. The method as recited in claim 2, wherein the primary icons are displayed in a horizontal arrangement within the fixed portion when the user interface is displayed in the landscape mode, the primary icons remaining fixed display during scrolling of the secondary icons.

7. The method as recited in claim 1, wherein the first input comprises a flick gesture input, and wherein the secondary icons continue scrolling for a duration of time after receipt of the flick gesture input.

8. The method as recited in claim 1, wherein the primary icons comprise a phone icon associated with a mobile phone function, a search icon associated with a search function, and a navigation icon associated with a navigation function employing a global positioning system of the mobile communication device.

9. The method as recited in claim 1, further comprising dynamically configuring the user interface to display icons as primary icons within the fixed portion or secondary icons within the movable portion based on a frequency of selection of the icons.

10. A mobile communication device comprising:
a display device operable to display information, the display device including a touch screen operable to receive touch input;
a memory operable to store a module; and
a processing system operable to execute the module to implement a user interface for display by the display device, the user interface including a main menu having a fixed portion and a movable portion, the fixed portion including primary icons associated with primary functions of the mobile communication device and the movable portion including secondary icons associated with secondary functions of the mobile communication device, wherein the secondary icons are configured to scroll within the movable portion upon receipt of an input via the touch screen while the primary icons within the fixed portion remain stationary with respect to the display device.

11. The mobile communication device as recited in claim 10, further comprising an orientation sensor operable to determine an orientation of the mobile communication device, the user interface configured to be displayed in one of a portrait mode and a landscape mode in response to the determined orientation.

12. The mobile communication device as recited in claim 11, wherein the movable portion is positioned to a side of the fixed portion with respect to the display device when the user interface is displayed in the portrait mode, the secondary icons being aligned vertically and scrolling in a vertical direction with respect to the display device.

13. The mobile communication device as recited in claim 11, wherein the movable portion is positioned below the fixed portion with respect to the display device when the user interface is displayed in the landscape mode, the secondary icons being aligned horizontally and scrolling in a horizontal direction with respect to the display device.

14. The mobile communication device as recited in claim 11, wherein the primary icons are displayed in a vertical arrangement within the fixed portion with respect to the display device when the user interface is displayed in the portrait mode, the primary icons remaining fixed with respect to the display device during scrolling of the secondary icons.

15. The mobile communication device as recited in claim 11, wherein the primary icons are displayed in a horizontal arrangement within the fixed portion with respect to the display device when the user interface is displayed in the landscape mode, the primary icons remaining fixed with respect to the display device during scrolling of the secondary icons.

16. The mobile communication device as recited in claim 10, wherein the input comprises a flick gesture input, and wherein the secondary icons continue scrolling for a duration of time after receipt of the flick gesture input.

17. The mobile communication device as recited in claim 10, further comprising a location determining component operable to receive satellite navigation signals and determine a current position of the mobile communication device using the received satellite navigation signals, wherein the primary icons comprise a navigation icon associated with a navigation function utilizing the current position.

18. The mobile communication device as recited in claim 10, wherein the module is configured to dynamically configure the user interface to display icons as primary icons within the fixed portion or secondary icons within the movable portion based on a frequency of selection of the icons.
